(19) United States
(12) Patent Application Publication
(10) Pub. No.: US 2018/0267683 A1
(43) Pub. Date: Sep. 20, 2018

(54) COOKING SYSTEM

(71) Applicant: Meyer Intellectual Properties Limited, Kowloon (HK)

(72) Inventors: Philip Tessier, Napa, CA (US); Christoph Milz, Vallejo, CA (US); Owen Hay, Vallejo, CA (US); Jordan Meyer, Vallejo, CA (US)

(73) Assignee: Meyer Intellectual Properties Limited, Kowloon (HK)

(21) Appl. No.: 15/923,879

(22) Filed: Mar. 16, 2018

Related U.S. Application Data
(60) Provisional application No. 62/473,293, filed on Mar. 17, 2017.

(51) Int. Cl. G06F 3/0485; G06F 3/0482; G09B 19/00; G09B 5/06

(52) U.S. Cl. CPC G06F 3/0485; G09B 5/065; G09B 19/0092; G06F 3/0482

(57) ABSTRACT

In one example, a portable device comprises one or more processors operable to determine a plurality of first food images and determine a plurality of second food images. Each of the first food images are associated with a respective first cooking recipe. Each of the second food images are associated with a respective second cooking recipe. The processors are further operable to transmit for display a first graphical image that includes a first column and a second column. The first column includes the first food images presented side-by-side. The second column includes the second food images presented side-by-side. The processors are further operable to receive an indication that the user has selected a particular first food image, to determine a subset of second food images, and to transmit for display a second graphical image that includes a second column that includes the subset of second food images presented side-by-side.

### CROSS-REFERENCE TO RELATED APPLICATIONS

This application claims priority to U.S. Provisional Patent Application No. 62/473,293 filed Mar. 17, 2017, the entirety of which is incorporated herein by reference.

### TECHNICAL FIELD

This disclosure relates generally to the field of cooking and more specifically to a cooking system.

### BACKGROUND

Traditionally, a user has cooked food by selecting a cookbook to review, selecting a recipe from the cookbook, and then following the instructions in the cookbook. Such a traditional cooking technique, however, may be deficient.

### SUMMARY

In a first example, a portable device comprises one or more memory units operable to store one or more instructions; and one or more processors communicatively coupled to the one or more memory units and operable, when executing the one or more instructions, to: determine a plurality of protein images, each of the plurality of protein images being associated with a respective protein cooking recipe; determine a plurality of sauce images, each of the plurality of sauce images being associated with a respective sauce cooking recipe; transmit for display a first graphical image that includes a first column for proteins and a second column for sauces, wherein the first column includes the plurality of protein images presented side-by-side in the first column, wherein the second column includes the plurality of sauce images presented side-by-side in the second column, wherein each of the plurality of protein images is selectable by a user, wherein each of the plurality of sauce images is selectable by the user, wherein the first graphical image is configured to separately scroll through each of the plurality of protein images in response to a request by the user, wherein the first graphical image is further configured to separately scroll through each of the plurality of sauce images in response to a request by the user; receive a first indication that the user has selected a first protein image of the plurality of protein images, wherein the first indication indicates that the user has selected the respective protein cooking recipe that is associated with the selected first protein image; following the reception of the first indication: determine, based on the selected protein cooking recipe, a subset of sauce images of the plurality of sauce images; and transmit for display a second graphical image that includes a second protein image associated with the selected protein cooking recipe, and that further includes a first column for proteins and a second column for sauces, wherein the first column of the second graphical image includes the plurality of protein images presented side-by-side in the first column of the second graphical image, wherein the second column of the second graphical image includes the subset of sauce images presented side-by-side in the second column of the second column, wherein the second graphical image is configured to separately scroll through each of the plurality of protein images in response to a request by the user, wherein the second graphical image is further configured to separately scroll through each of the subset of sauce images in response to a request by the user; receive a second indication that the user has selected a first sauce image of the subset of sauce images, wherein the second indication indicates that the user has selected the respective sauce cooking recipe that is associated with the selected first sauce image; and following the reception of the second indication: transmit for display a third graphical image that includes the second protein image associated with the selected protein cooking recipe, and that further includes a second sauce image associated with the selected sauce cooking recipe, and that further includes a first column for proteins and a second column for sauces, wherein the first column of the third graphical image includes the plurality of protein images presented side-by-side in the first column of the third graphical image, wherein the second column includes the subset of sauce images presented side-by-side in the second column of the third graphical image, wherein the third graphical image is configured to separately scroll through each of the plurality of protein images in response to a request by the user, wherein the third graphical image is further configured to separately scroll through each of the subset of sauce images in response to a request by the user; receive a third indication that the user has selected to proceed with the selected protein cooking recipe and the selected sauce cooking recipe; following reception of the third indication: determine ingredients associated with the selected protein cooking recipe and the selected sauce cooking recipe; transmit for display a fourth graphical image that includes the determined ingredients; and receive a fourth indication that the user has selected to begin cooking the selected protein cooking recipe and the selected sauce cooking recipe; and following reception of the fourth indication, transmit for display a plurality of additional graphical images, wherein each of the plurality of additional graphical images includes one or more steps associated with cooking the selected protein cooking recipe and the selected sauce cooking recipe.

In a second example, a portable device comprises one or more memory units operable to store one or more instructions; and one or more processors communicatively coupled to the one or more memory units and operable, when executing the one or more instructions, to: determine a plurality of first food images, each of the plurality of first food images being associated with a respective first cooking recipe of a plurality of first cooking recipes; determine a plurality of second food images, each of the plurality of second food images being associated with a respective second cooking recipe of a plurality of second cooking recipes; transmit for display a first graphical image that includes a first column and a second column, wherein the first column includes the plurality of first food images presented side-by-side in the first column, wherein the second column includes the plurality of second food images presented side-by-side in the second column, wherein each of the plurality of first food images is selectable by a user, wherein each of the plurality of second food images is selectable by the user, wherein the first graphical image is configured to separately scroll through each of the plurality of first food images in response to a request by the user, wherein the first graphical image is further configured to separately scroll through each of the plurality of second food images in response to a request by the user; receive a first indication that the user has selected a particular first food image of the plurality of first food images, wherein the first indication indicates that the user has selected the respective first cooking recipe that is associated with the selected first food image; following the reception of the first indication: determine, based on the selected first cooking recipe, a subset of second food images of the plurality of second food images; and transmit for display a second graphical image that includes a third food image associated with the selected first cooking recipe, and that further includes a first column and a second column, wherein the first column of the second graphical image includes the plurality of first food images presented side-by-side in the first column of the second graphical image, wherein the second column of the second graphical image includes the subset of second food images presented side-by-side in the second column of the second column, wherein the second graphical image is configured to separately scroll through each of the plurality of first food images in response to a request by the user, wherein the second graphical image is further configured to separately scroll through each of the subset of second food images in response to a request by the user; receive a second indication that the user has selected a particular second food image of the subset of second food images, wherein the second indication indicates that the user has selected the respective second cooking recipe that is associated with the selected second food image; and following the reception of the second indication, transmit for display a third graphical image that includes the third food image associated with the selected first cooking recipe, and that further includes a fourth food image associated with the selected second cooking recipe, and that further includes a first column and a second column, wherein the first column of the third graphical image includes the plurality of first food images presented side-by-side in the first column of the third graphical image, wherein the second column includes the subset of second food images presented side-by-side in the second column of the third graphical image, wherein the third graphical image is configured to separately scroll through each of the plurality of first food images in response to a request by the user, wherein the third graphical image is further configured to separately scroll through each of the subset of second food images in response to a request by the user.

Another example includes any such portable device, wherein the one or more processors are further operable, when executing the one or more instructions, to: receive a third indication that the user has selected to proceed with the selected first cooking recipe and the selected second cooking recipe; following reception of the third indication: determine ingredients associated with the selected first cooking recipe and the selected second cooking recipe; transmit for display a fourth graphical image that includes the determined ingredients; and receive a fourth indication that the user has selected to begin cooking the selected first cooking recipe and the selected second cooking recipe; and following reception of the fourth indication, transmit for display a plurality of additional graphical images, wherein each of the plurality of additional graphical images includes one or more steps associated with cooking the selected first cooking recipe and the selected second cooking recipe.

Another example includes any such portable device, wherein the one or more processors are further operable, when executing the one or more instructions, to: receive a third indication that the user has selected to proceed with the selected first cooking recipe and the selected second cooking recipe; and following reception of the third indication, transmit for display a plurality of additional graphical images, wherein each of the plurality of additional graphical images includes one or more steps associated with cooking the selected first cooking recipe and the selected second cooking recipe.

Another example includes any such portable device, wherein the plurality of first cooking recipes is a plurality of main course cooking recipes, a plurality of beef cooking recipes, a plurality of fish cooking recipes, a plurality of tofu cooking recipes, or a plurality of protein cooking recipes.

Another example includes any such portable device, wherein the plurality of second cooking recipes is a plurality of side dish cooking recipes, a plurality of dessert recipes, or a plurality of sauce cooking recipes.

Another example includes any such portable device, wherein the subset of second food images comprises food images that are each associated with a respective second cooking recipe of a subset of the plurality of second cooking recipes, wherein each of the second cooking recipes of the subset of the plurality of second cooking recipes is associated with the selected first cooking recipe.

In a third example, a method comprises determining, by one or more processors, a plurality of first food images, each of the plurality of first food images being associated with a respective first cooking recipe of a plurality of first cooking recipes; determining, by the one or more processors, a plurality of second food images, each of the plurality of second food images being associated with a respective second cooking recipe of a plurality of second cooking recipes; transmitting, by the one or more processors, for display a first graphical image that includes a first column and a second column, wherein the first column includes the plurality of first food images presented side-by-side in the first column, wherein the second column includes the plurality of second food images presented side-by-side in the second column, wherein each of the plurality of first food images is selectable by a user, wherein each of the plurality of second food images is selectable by the user, wherein the first graphical image is configured to separately scroll through each of the plurality of first food images in response to a request by the user, wherein the first graphical image is further configured to separately scroll through each of the plurality of second food images in response to a request by the user; receiving, by the one or more processors, a first indication that the user has selected a particular first food image of the plurality of first food images, wherein the first indication indicates that the user has selected the respective first cooking recipe that is associated with the selected first food image; following the reception of the first indication: determining, by the one or more processors and based on the selected first cooking recipe, a subset of second food images of the plurality of second food images; and transmitting, by the one or more processors, for display a second graphical image that includes a third food image associated with the selected first cooking recipe, and that further includes a first column and a second column, wherein the first column of the second graphical image includes the plurality of first food images presented side-by-side in the first column of the second graphical image, wherein the second column of the second graphical image includes the subset of second food images presented side-by-side in the second column of the second column, wherein the second graphical image is configured to separately scroll through each of the plurality of first food images in response to a request by the user, wherein the second graphical image is further configured to separately scroll through each of the subset of second food images in response to a request by the user; and receiving, by the one or more processors, a second indication that the user has selected a particular second food image of the subset of second food images, wherein the second indication indicates that the user has selected the respective second cooking recipe that is associated with the selected second food image; and following the reception of the second indication, transmitting, by the one or more processors, for display a third graphical image that includes the third food image associated with the selected first cooking recipe, and that further includes a fourth food image associated with the selected second cooking recipe, and that further includes a first column and a second column, wherein the first column of the third graphical image includes the plurality of first food images presented side-by-side in the first column of the third graphical image, wherein the second column includes the subset of second food images presented side-by-side in the second column of the third graphical image, wherein the third graphical image is configured to separately scroll through each of the plurality of first food images in response to a request by the user, wherein the third graphical image is further configured to separately scroll through each of the subset of second food images in response to a request by the user.

In a fourth example, a non-transitory computer readable medium comprises logic configured, when executed by one or more processors, to determine a plurality of first food images, each of the plurality of first food images being associated with a respective first cooking recipe of a plurality of first cooking recipes; determine a plurality of second food images, each of the plurality of second food images being associated with a respective second cooking recipe of a plurality of second cooking recipes; transmit for display a first graphical image that includes a first column and a second column, wherein the first column includes the plurality of first food images presented side-by-side in the first column, wherein the second column includes the plurality of second food images presented side-by-side in the second column, wherein each of the plurality of first food images is selectable by a user, wherein each of the plurality of second food images is selectable by the user, wherein the first graphical image is configured to separately scroll through each of the plurality of first food images in response to a request by the user, wherein the first graphical image is further configured to separately scroll through each of the plurality of second food images in response to a request by the user; receive a first indication that the user has selected a particular first food image of the plurality of first food images, wherein the first indication indicates that the user has selected the respective first cooking recipe that is associated with the selected first food image; following the reception of the first indication: determine, based on the selected first cooking recipe, a subset of second food images of the plurality of second food images; and transmit for display a second graphical image that includes a third food image associated with the selected first cooking recipe, and that further includes a first column and a second column, wherein the first column of the second graphical image includes the plurality of first food images presented side-by-side in the first column of the second graphical image, wherein the second column of the second graphical image includes the subset of second food images presented side-by-side in the second column of the second column, wherein the second graphical image is configured to separately scroll through each of the plurality of first food images in response to a request by the user, wherein the second graphical image is further configured to separately scroll through each of the subset of second food images in response to a request by the user; receive a second indication that the user has selected a particular second food image of the subset of second food images, wherein the second indication indicates that the user has selected the respective second cooking recipe that is associated with the selected second food image; and following the reception of the second indication, transmit for display a third graphical image that includes the third food image associated with the selected first cooking recipe, and that further includes a fourth food image associated with the selected second cooking recipe, and that further includes a first column and a second column, wherein the first column of the third graphical image includes the plurality of first food images presented side-by-side in the first column of the third graphical image, wherein the second column includes the subset of second food images presented side-by-side in the second column of the third graphical image, wherein the third graphical image is configured to separately scroll through each of the plurality of first food images in response to a request by the user, wherein the third graphical image is further configured to separately scroll through each of the subset of second food images in response to a request by the user.

In a fifth example, an electronic cookbook provides a Graphic User Interface (GUI) for recipe selection, review and execution. The GUI provides for the selection of complimentary menu items to create a broad range of meal choices. The ingredients, portions and recipe execution steps are present in an integrated chart or task list based on the user's selection to facilitate manual or any combination of manual and cooking appliance automated cooking.

### BRIEF DESCRIPTION OF THE FIGURES

For a more complete understanding of the present disclosure and its features and advantages, reference is now made to the following description, taken in conjunction with the accompanying drawings, in which:

FIGS. 1A-1B illustrate an example cooking system that may assist a user in cooking a food item; and

FIGS. 2-15 illustrate example graphical images.

### DETAILED DESCRIPTION

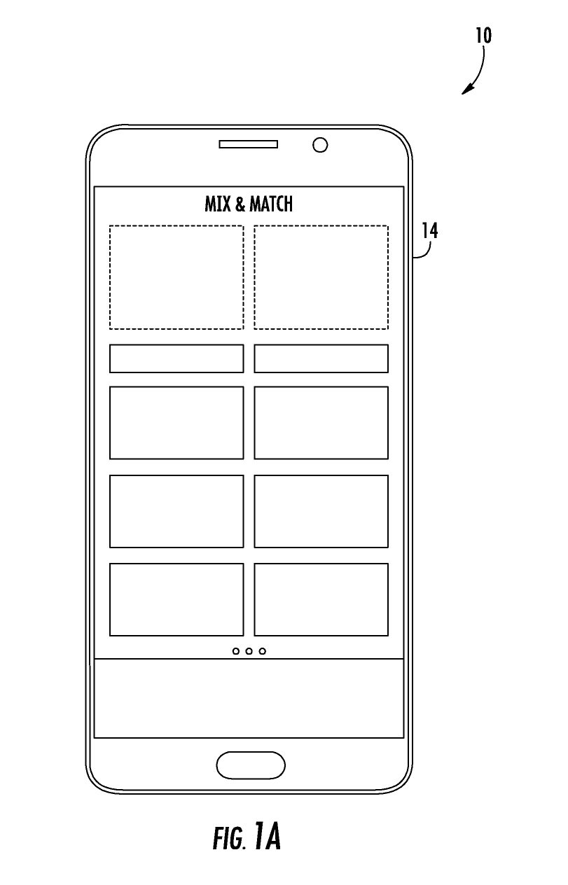

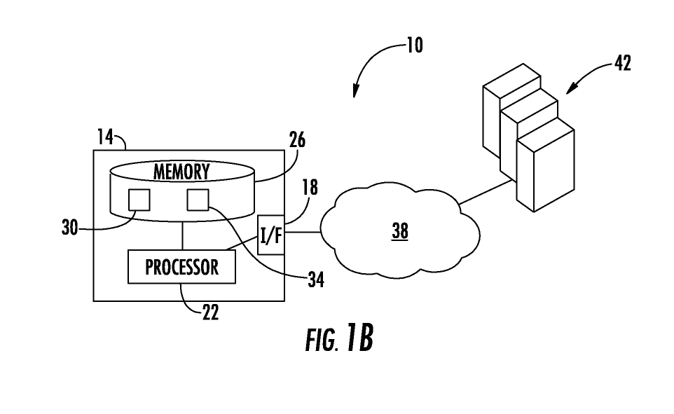

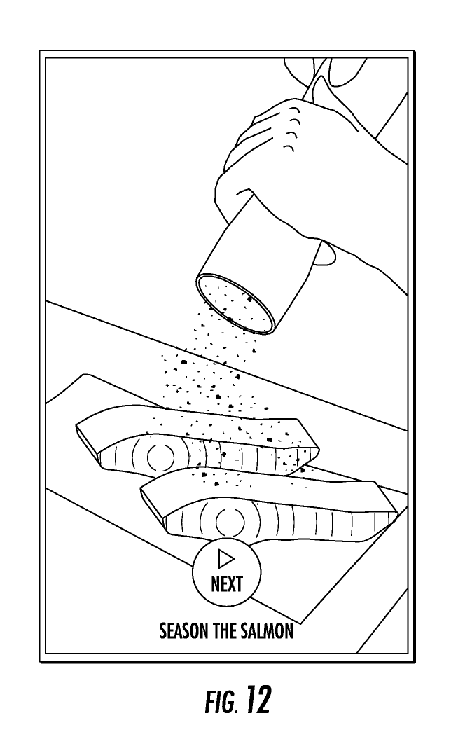

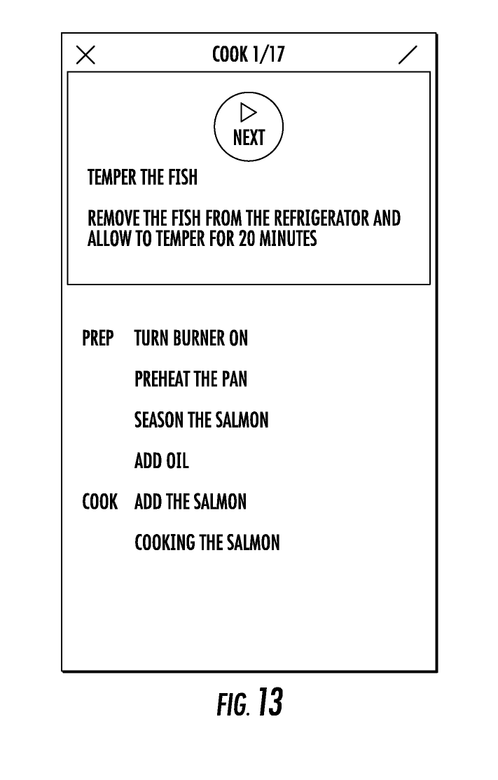

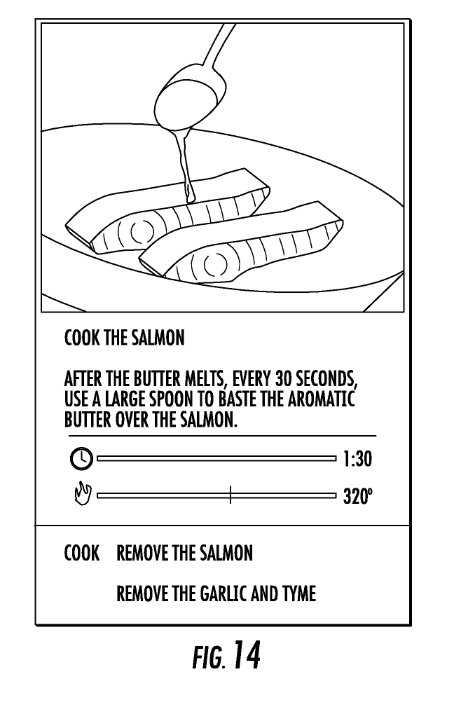

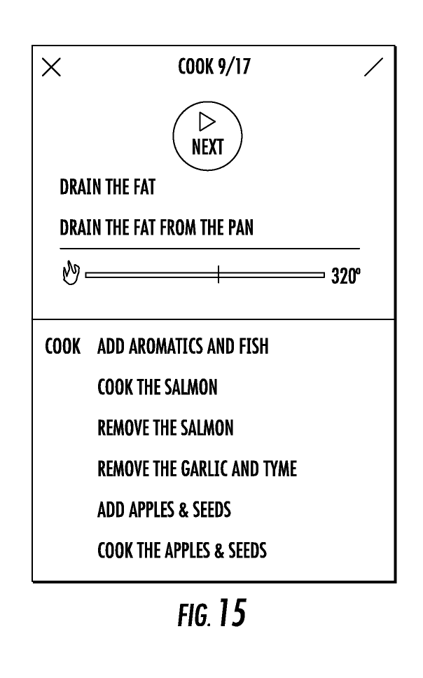

Embodiments of the present disclosure are best understood by referring to FIGS. 1A-15 of the drawings, like numerals being used for like and corresponding parts of the various drawings.

FIGS. 1A-1B illustrate an example cooking system 10 that may assist a user in cooking a food item (such as a steak). As is illustrated, the cooking system 10 includes a computing device 14 (such as a mobile phone or tablet) that may execute an electronic cookbook 30. The electronic cookbook 30 may allow a user to view and/or select a cooking recipe to cook, and may further assist the user in cooking. The cooking system 10 further includes a database 42 that may include various remotely stored cooking recipes. The computing device 14 may access the database 42 to retrieve one or more of the remotely stored cooking recipes.

Computing device 14 represents any suitable components that may communicate with a user so as to provide cooking information (such as cooking recipes) to the user. Computing device 14 may be a computer, a laptop, a mobile telephone or cellular telephone (such as a Smartphone), an electronic notebook, a tablet (such as an iPad), a personal digital assistant, a video projection device, a cooking appliance with a display unit, any other device capable of receiving, processing, storing, and/or communicating information with other components of system 10, or any combination of the preceding. The computing device 14 may be a portable computing device that is designed to be carried around by a user and/or that may operate while being carried around by a user (e.g., a laptop computer, a Smartphone). Alternatively, the computing device 14 may be a non-portable device that is designed to not be moved while operating (e.g., a desktop computer, a large screen television, a refrigerator with a display screen). As is illustrated in FIGS. 1A-1B, the computing device 14 is a tablet (such as an iPad). Furthermore, as illustrated, computing device 14 includes a network interface 18, a processor 22, and a memory unit 26. Also, the computing device 14 may include one or more user interfaces, such as a keyboard, a mouse, and/or a display screen (e.g., a touch-enabled display screen).

Network interface 18 represents any suitable device operable to receive information from network 38, transmit information through network 38, perform processing of information, communicate with other devices, or any combination of the preceding. For example, network interface 18 may receive remotely stored cooking recipes from the database 42. Network interface 18 represents any port or connection, real or virtual, (including any suitable hardware and/or software, including protocol conversion and data processing capabilities, to communicate through a local area network (LAN), a metropolitan area network (MAN), a wide area network (WAN), or other communication system) that allows computing device 14 to exchange information with network 38, database 42, or other components of system 10.

Processor 22 communicatively couples to network interface 18 and memory unit 26, and controls the operation and administration of computing device 14 by processing information received from network interface 18 and memory unit 26. Processor 22 includes any hardware and/or software that operates to control and process information. For example, processor 22 executes an electronic cookbook 30 to control the operation of computing device 14, such as to cause the computing device 14 to communicate with a user so as to provide cooking information 34 (such as cooking recipes) to the user. Processor 22 may be a programmable logic device, a digital signal processor (DSP), a microcontroller, a microprocessor, a programmable logic controller (PLC), a controller, a logic circuit, an analog controller, any other processing device or the like, or any combination of the preceding.

Memory unit 26 stores, either permanently or temporarily, data, operational software, or other information for processor 22. Memory unit 26 includes any one or a combination of volatile or non-volatile local or remote devices suitable for storing information. For example, memory unit 26 may include random access memory (RAM), read only memory (ROM), magnetic storage devices, optical storage devices, any other suitable information storage device, or any combination of the preceding. The memory unit 26 may be (or may include) a non-transitory computer readable medium. The term “non-transitory”, as used herein, is a limitation of the medium itself (i.e., tangible, not a signal) as opposed to a limitation on data storage persistency (e.g., RAM vs. ROM). While illustrated as including particular information modules, memory unit 26 may include any suitable information for use in the operation of computing device 14.

As illustrated, memory unit 26 includes the electronic cookbook 30 and cooking information 34. Electronic cookbook 30 represents any suitable set of instructions, logic, or code embodied in a computer-readable storage medium and operable to facilitate the operation of computing device 14 with regard to cooking and/or the electronic cookbook 30. Examples details regarding electronic cookbook 30 are discussed below. Cooking information 34 represents any type of information that may be used to cook one or more food items. For example, cooking information may include cooking recipes, quantities of ingredients included in cooking recipes (for differing numbers of servings), steps and/or stages included in cooking recipes, text of cooking instructions, video data of cooking instructions being executed, number of cooking steps/stages, time and temperature measurements for each cooking stage/step, graphical images of cooking ingredients, graphical images of cooked recipes, cooking tutorials, associations between different cooking recipes, the order of steps/stages in a cooking recipe when a cooking recipe is combined with other cooking recipe(s), any other information that may be used to cook food items, or any combination of the preceding. Although electronic cookbook 30 and cooking information 34 are illustrated as being separate, in some examples the electronic cookbook 30 may include the cooking information 34 (or vice versa).

Memory unit 26 may further include any other suitable set of instructions, logic, or code embodied in computer-readable storage medium and operable to facilitate other operations of computing device 14, such as a telephone function of the computing device 14, any other Smartphone or tablet function of the computing device 14, any other function of the computing device 14, or any combination of the preceding.

The electronic cookbook 30 may provide the user with instructions (and other content) associated with cooking. For example, the electronic cookbook 30 may provide the user with one or more cooking recipes and additional content that may assist the user in cooking a food item (such as a steak or chili). The electronic cookbook 30 may access cooking information 34 in order to provide the user with instructions (and other content) associated with cooking.

The electronic cookbook 30 may utilize a display screen of the computing device 14 (or any other device in communication range of the computing device 14, such as a small projection display or a conveniently located display built into an appliance (e.g., a front panel display (FPD) on refrigerator)) to allow a user to easily view, receive, or play the recipe instructions. To do so, the display screen may display one or more graphical user interfaces that include the recipe instructions and/or any other information of the electronic cookbook 30.

When executed by the computing device 14, the electronic cookbook 30 may display content associated with cooking in one or more graphical user interfaces. The user may navigate through the electronic cookbook 30 in order to select a particular cooking recipe to be used to cook a food item. Once a particular recipe (such as a recipe for chili, for example) has been selected, the electronic cookbook 30 may display on the computing device 14 the cooking recipe associated with the selected food item. The electronic cookbook 30 may display the entire cooking recipe on the computing device 14, or only a portion of the cooking recipe on the computing device 14.

The cooking recipe may include any information that may be utilized in cooking the food item, such as steps (or stages) for preparing the food item, a list of ingredients for the food item, a list of quantities of ingredients for the food item, a list of substitute ingredients for the food item, a list of devices or appliances that may be used to cook the food item (such as a description and/or picture of a particular pot/pan, a description and/or picture of a particular type of appliance (such as an oven or grill) that should be used to cook the food item, etc.), any other information associated with the food item, or any combination of the preceding. The cooking recipe may also include instructional videos associated with cooking the food item and/or pictures associated with ingredients of the food item (such as a picture of an onion, a picture of a diced onion, a picture of what an onion looks like after being caramelized, etc.).

The electronic cookbook 30 may further include a step-by-step guide for cooking the food item in accordance with the cooking recipe. This step-by-step guide may navigate the user through each step in the cooking process. For example, the cooking recipe for chili may include the following steps: (1) meat is added to the pot and browned at a particular temperature (such as 375° F.) for a particular duration of time (such as 10 minutes); (2) onions and or other ingredients are added to the browned meat; (3) this combination of ingredients is cooked at a second particular temperature (such as 300° F.) for a second particular duration of time (such as 5 minutes); (4) tomatoes, tomato sauce, and spices are added; (5) this combination of ingredients is cooked at a third particular temperature (such as 212° F.) for a third particular duration (till the tomato sauce combination is reduced by ½); and (6) the entire food item is cooked at a fourth temperature (such as 180° F.) for a fourth particular duration of time (such as 4 hours).

In the step-by-step guide, each of the above example steps for chili may be displayed individually (or individually highlighted in the cooking recipe to identify the current step). For a current step, the computing device 14 may display information that explains the current step in the cooking recipe, and further explains what the user is supposed to do during that step. Once the step has been completed, the user may be prompted to indicate that the step has been completed, such as by clicking on a “next” button displayed on the computing device 14. This may allow the user to navigate to the next step. The user may click on a button of the computing device 14 or the screen of the computing device 14 to activate such a “next” button.

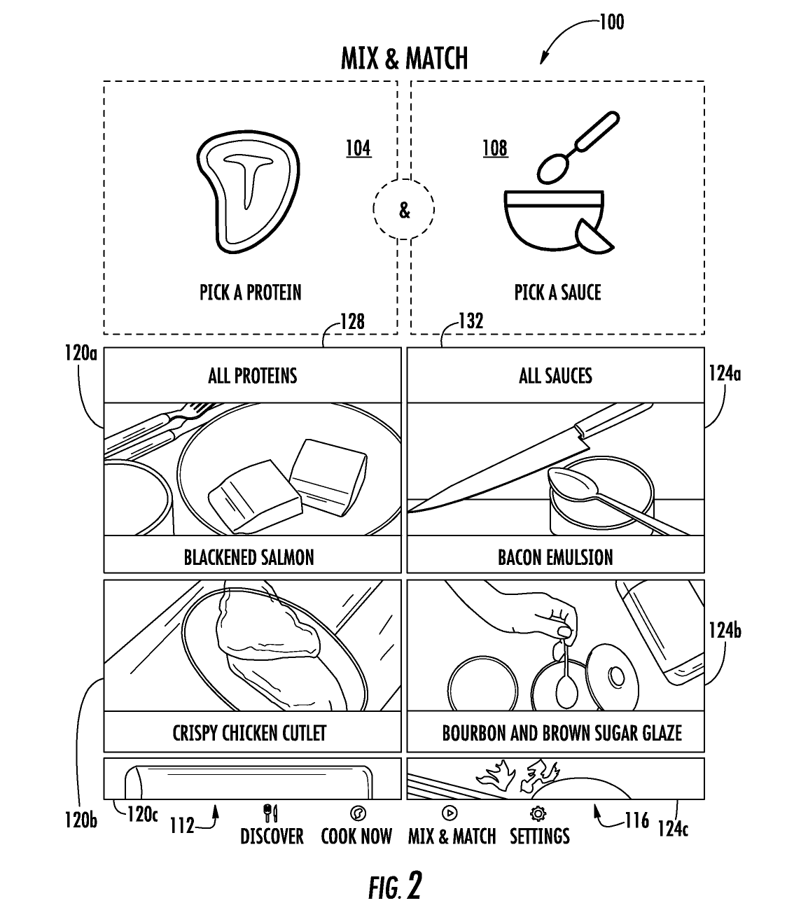

Additional information regarding the electronic cookbook 30 and cooking information 34 (which may be utilized by the electronic cookbook 30) is discussed below. Additionally, example screenshots displayed by the electronic cookbook 30 on the computing device 14 (or any other device) are illustrated in FIGS. 2-15. Furthermore, additional information regarding the electronic cookbook 30 is discussed in detail in U.S. Patent Application Publication No. 2017/0238749 (the entirety of which is incorporated herein by reference). The electronic cookbook 30 and/or the computing device 14 may have any of the functionalities discussed in U.S. Patent Application Publication No. 2017/0238749.

Network 38 represents any suitable network operable to facilitate communication between the components of system 10, such as computing device 14 and database 42. Network 38 may include any interconnecting system capable of transmitting audio, video, signals, data, messages, or any combination of the preceding. Network 38 may include all or a portion of a public switched telephone network (PSTN), a public or private data network, a LAN, a MAN, a WAN, a wireless personal area network (WPAN), a local, regional, or global communication or computer network (such as the Internet), a wireline or wireless network, an enterprise intranet, or any other suitable communication link, including combinations thereof, operable to facilitate communication between the components. Preferable examples of network 38 may include a WPAN (which may include, for example, Bluetooth, Bluetooth low power, Bluetooth 5, ANT+, Zigbee (IEEE 802.15.4), other IEEE 802.15 protocols, IEEE 802.11 A, B or G without limitation, and Wi-FI (IEEE 802.11)), a cellular communication network, an infrared communication network, any other wireless network operable to facilitate communication between the components, or any combination of the preceding.

Database 42 represents any suitable components that may store cooking information 34 in a location remotely from computing device 14. Database 42 may include a network server, any suitable remote server, a mainframe, a database, a host computer, a workstation, a web server, a personal computer, a laptop, a mobile telephone (such as a Smartphone), an electronic notebook, a personal digital assistant, a file server, any other suitable device for storing information, or any combination of the preceding. The cooking information 34 stored by database 42 may be accessible to the computing device 14 (and the electronic cookbook 30). As such, if a user desires to cook a cooking recipe (or other cooking information 34) that is not stored on the computing device 14, the computing device 14 may communicate with the database 42 in order to retrieve the cooking recipe (or other cooking information 34). The cooking information 34 stored on the database 42 may be the same as the cooking information 34 stored on the computing device 14. As such, the database 42 may be a back-up of the cooking information 34 already stored on the computing device 14. Additionally (or alternatively), the cooking information 34 stored on the database 42 may be different (or partially different) from the cooking information 34 stored on the computing device 14. This may allow the computing device 14 to access additional cooking information 34 (such as additional cooking recipes) while preventing the computing device 14 from having to actually store it in its own memory unit 26.

Modifications, additions, and/or substitutions may be made to the cooking system 10, the components of the cooking system 10, and/or the functions of the cooking system 10 without departing from the scope of the specification. For example, the computing device 14 of cooking system 10 may include any number of processors 22 and memory units 26 (such as two or more processors 22 and/or two or more memory units 26). Furthermore, the processes performed by a processor 22 may be distributed among multiple processors 22, and/or the information stored by memory unit 26 may be distributed among multiple memory units 26.

As another example, cooking system 10 may include any number of databases 42 (such as two or more databases 42). As a further example, the cooking system 10 may include other components, such as a heat source system that may provide an amount of energy to cook a food item and that may further communicate with computing device 14; a heat source (such as a burner or grill) that may provide an amount of energy to cook a food item; a cooking device system that may communicate with the heat source system and/or computing device 14 to assist the user in cooking; a cooking device (such as a pot or a pan) that may be used in cooking a food item; any other element described (and/or claimed) in U.S. Patent Application Publication No. 2017/0238749 (the entirety of which is incorporated herein by reference); any other cooking/food preparation component, or any combination of the preceding.

In an exemplary embodiment of operation of cooking system 10, a user may desire to cook a meal, but may not know what meal the user desires to cook. As another example, the user may be hosting a party, and may want to allow his guests an opportunity to help select what to cook. In such examples, the user may utilize computing device 14 (and electronic cookbook 30 and cooking information 34) to assist the user in selecting one or more food items to cook, and may further utilize computing device 14 (and electronic cookbook 30 and cooking information 34) to cook the selected food items.

To receive such assistance, the user may cause the computing device 14 to execute the electronic cookbook 30. The user may cause the computing device 14 to execute the electronic cookbook 30 in any manner. For example, the electronic cookbook 30 may be an “app” installed on the computing device 14. In such an example, the user may cause the computing device 14 to execute the electronic cookbook 30 by selecting an icon for the electronic cookbook 30 displayed on the computing device 14.

Once executed by the computing device 14, the electronic cookbook 30 may display content associated with cooking. The electronic cookbook 30 may display such content by accessing cooking information 34 (stored on the computing device 14 or accessed from database 42), and generating one or more graphical images that include the cooking information 34. These graphical images may then be transmitted for display to the user (e.g., transmitted for display on the screen of the computing device 14, or any other screen).

The user may navigate through the electronic cookbook 30 in order to select a particular cooking recipe to be used to cook a food item. The user may navigate through the electronic cookbook 30 in any manner. For example, the user may utilize a search function of the electronic cookbook 30 to search for a particular cooking recipe (in cooking information 34). As another example, the user may have stored favorite cooking recipes in a particular section of the electronic cookbook 30. In such an example, the user may navigate to that section (such as by clicking on the “favorites” tab in the electronic cookbook 30) in order to select a particular cooking recipe. As a further example, the electronic cookbook 30 may include suggested recipes and/or recipes that have been rated by other users or by celebrity chefs. As another example, the user may scroll through all (or a portion) of the cooking recipes to select a particular recipe.

In a preferred example, the user may activate a mix and match function of the electronic cookbook 30 to search for two or more particular cooking recipes (in cooking information 34) to combine in order to make a meal. The user may activate the mix and match function in any manner. For example, the user may click on a “mix and match” tab (or button) in a graphical image presented by the electronic cookbook 30.

Following activation, the computing device 14 may generate and transmit a first graphical image for display to the user, so as to assist the user in selecting particular cooking recipes. The first graphical image may be displayed on the screen of the computing device 14, or in some examples, may be displayed on any other screen or device in communication with the computing device 14. An example of the first graphical image is illustrated in FIG. 2 as graphical image 100.

As illustrated, graphical image 100 may allow a user to select two different types of cooking recipes: (1) a protein cooking recipe; and (2) a sauce cooking recipe. A protein cooking recipe refers to a recipe for cooking any type of food item that includes protein. Examples of such food items include eggs, fish, beef, pork, veal, lamb, game meat(s), turkey, seafood, poultry, fowl, plant items, dairy items, and/or any other food item that includes protein. A sauce cooking recipe refers to a recipe for cooking any type of sauce food item. Examples of such food items include Alfredo sauce, pear and almond brown butter sauce, pumpkin seed and apple brown butter, tartar sauce, Hollandaise sauce, Béarnaise sauce, brown butter sauce, salsa, carrot ginger sauce, cream sauce, tomato sauce(s), butter thickened sauce(s), vegan sauce(s), any other hot sauce, any other cold sauce, and/or any other sauce.

Although graphical image 100 is illustrated as including protein cooking recipes and sauce cooking recipes, graphical image 100 (and any other image discussed herein) may include any other types of cooking recipes. For example, instead of protein cooking recipes, graphical image 100 may include main course cooking recipes, beef cooking recipes, fish cooking recipes, tofu cooking recipes, or any other category of recipe. As another example, instead of sauce cooking recipes, graphical image 100 may include side dish recipes (such as rice and/or vegetables), dessert recipes, preparation type recipes (e.g., if the first selected cooking recipe is salmon, the preparation type recipes may be smoked, grilled, fried, baked, etc.), sub-category recipes (e.g., if the first selected cooking recipe is seafood, the sub-category recipes may be shrimp, crabs, mussel, squid, etc.), or any other category of recipe.

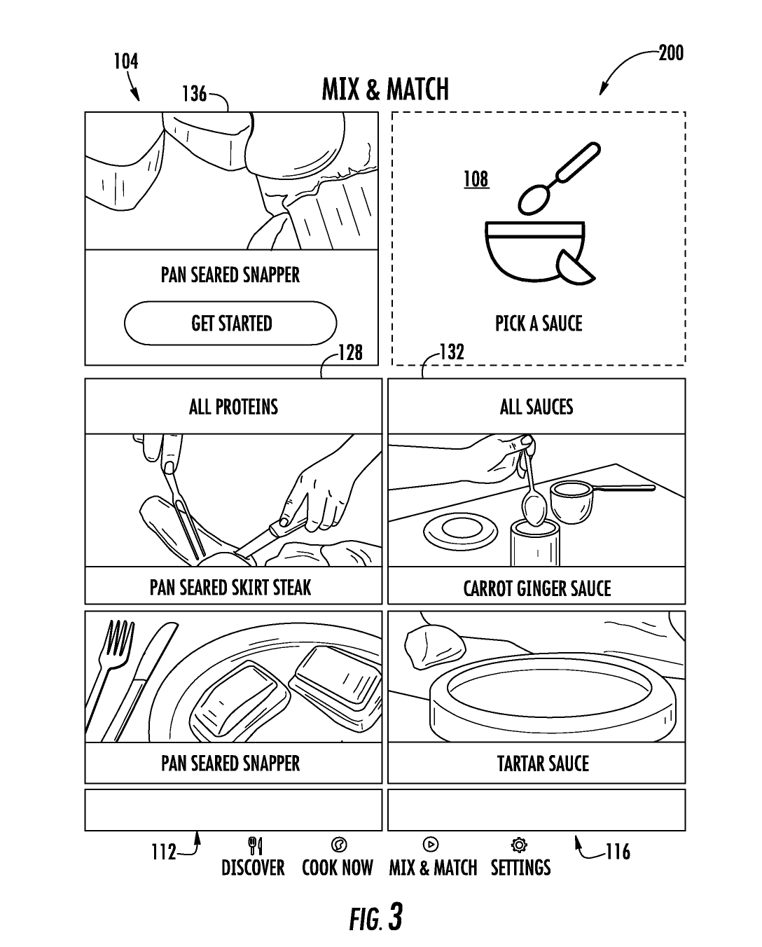

As is illustrated, graphical image 100 includes a selected protein cooking recipe area 104. Selected protein cooking recipe area 104 may refer to an area in the graphical image 100 that may be used to display a protein cooking recipe that has already been selected by the user. For example, once the user selects a particular protein cooking recipe, an image associated with that protein cooking recipe may be displayed in area 104. As is illustrated in FIG. 2, area 104 is blank, as a particular protein cooking recipe has not yet been selected. FIG. 3 illustrates an example where area 104 has been filled with an image of the selected protein cooking recipe. Selected protein cooking recipe area 104 may be located in any area of the graphical image 100. For example, it may be located at the top, bottom, left side, right side, or in the middle of the graphical image 100. In a preferred example, area 104 is located at the top of the graphical image 100, in a location that is in-line with protein column 112 (discussed below), but that is also set apart from the protein column 112, as is seen in FIG. 2.

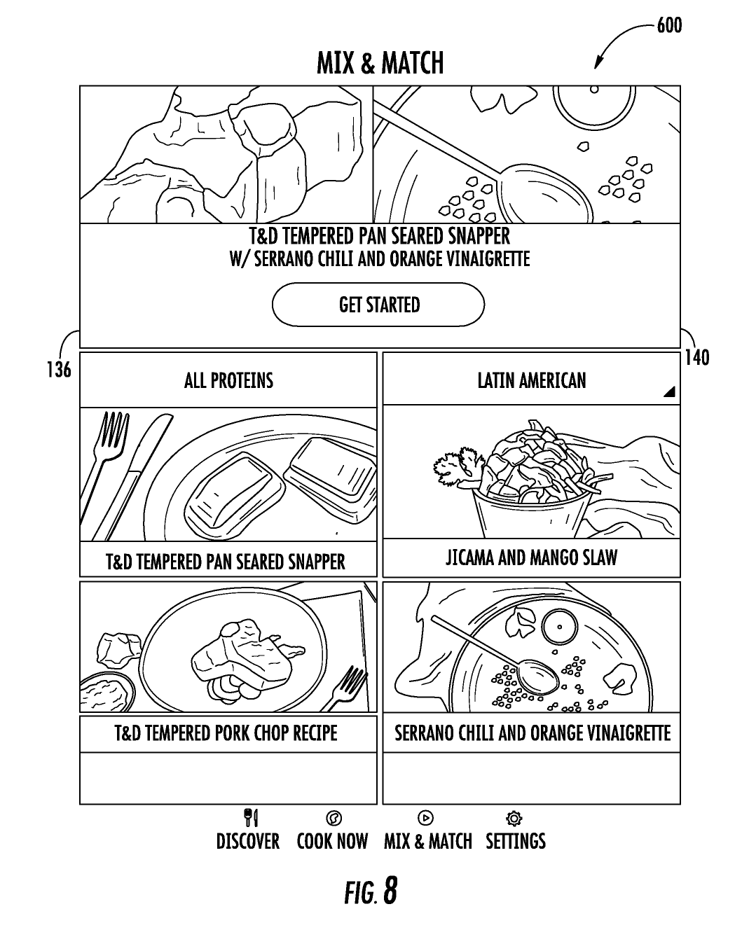

Graphical image 100 further includes a selected sauce cooking recipe area 108. Selected sauce cooking recipe area 108 may refer to an area in the graphical image 100 that may be used to display a sauce cooking recipe that has already been selected by the user. For example, once the user selects a particular sauce cooking recipe, an image associated with that sauce cooking recipe may be displayed in area 108. As is illustrated in FIG. 2, area 108 is blank, as a particular sauce cooking recipe has not yet been selected. FIG. 8 illustrates an example where area 108 has been filled with an image of the selected sauce cooking recipe. Selected sauce cooking recipe area 108 may be located in any area of the graphical image 100. For example, it may be located at the top, bottom, left side, right side, or in the middle of the graphical image 100. In a preferred example, area 108 is located at the top of the graphical image 100, in a location that is in-line with sauce column 116 (discussed below), but that is also set apart from the sauce column 116, as is seen in FIG. 2.

Graphical image 100 further includes a protein column 112. Protein column 112 may refer to an area in the graphical image 100 that may be used to display one or more protein cooking recipes that can be selected by the user. Protein column 112 may have any size and/or shape. Furthermore, protein column 112 may include any number of protein cooking recipes that can be selected by the user. For example, protein column 112 may include one protein cooking recipe, two protein cooking recipes, 10 protein cooking recipes, 100 protein cooking recipes, 1000 protein cooking recipes, or any other number of protein cooking recipes. Additionally, although protein column 112 is referred to as a column, it may be any array of protein cooking recipes or any other arrangement of protein cooking recipes. For example, the protein column 112 may be a vertical array of protein cooking recipes (e.g., a column, as is illustrated in FIG. 2), a horizontal/lateral array of protein cooking recipes (e.g., a row), a circular array of protein cooking recipes (e.g., a circular column, a circular row), any other type of array of protein cooking recipes, or any other arrangement of protein cooking recipes. As another example, each cooking recipe may be included on a different graphical image 100. As a further example, the protein column 112 may be a textual list of protein cooking recipes. As another example, the protein column 112 may be a selectable menu that presents one or more cooking recipes in a selectable list, or in selectable subcategories (e.g., meats, fish).

Protein column 112 may include protein cooking recipes in any manner. As an example, protein column 112 may include protein cooking recipes by including a list of names associated with the protein cooking recipes, a list of images associated with the protein cooking recipes, any other manner of identifying the protein cooking recipes for the user, or any combination of the preceding. As is illustrated, protein column 112 includes images associated with the protein cooking recipes. These images are illustrated as protein images 120 (e.g., 120a, 120b, and 120c). The image associated with the protein cooking recipe may be any image that may identify the protein cooking recipe for the user. For example, the image may be a photograph of the end result of the protein cooking recipe, a drawing of the end result of the protein cooking recipe, any other illustration that may identify the protein cooking recipe for the user, or any combination of the preceding. As is illustrated, the images 120 included in the protein column 112 include a photograph of the end result of each protein cooking recipe (e.g., the image for a protein cooking recipe for blackened salmon is a photograph of all or a portion of the fully (or partially) cooked/prepared blackened salmon). Furthermore, the images 120 also include a name associated with each of the protein cooking recipes (e.g., the image for blackened salmon includes the name “Blackened Salmon”). The name may be superimposed on the photograph, as is illustrated in FIG. 2.

The images 120 may be included within the protein column 112 in any manner. For example, as is illustrated, each image 120 may be included within the protein column 112 so as to be side-by-side (such as vertically side-by-side) with a subsequent image 120. The images 120 may be included in any order within the protein column 112. For example, the images 120 may be included in alphabetical order, popularity order (with the most popular cooking recipes being listed first), user popularity order (with the particular user's most popular cooking recipes being listed first), order of storage, order of loading on the graphical image 100, any other order, or any combination of the preceding.

Protein column 112 (and the images 120 included within protein column 112) may be scrollable. For example, even though only two images 120 (120a and 120b) are fully shown in FIG. 2, the user may scroll down (or up) in order to be presented with additional images 120. This may allow the user to scroll through any number of images 120 included within the protein column 112. The user may scroll through the images 120 in any manner. For example, a user may flick (or slide) their finger upward on the screen (e.g., a touch activated screen) and over the images 120 so as to cause the protein column 112 to scroll down and show additional images 120. As another example, the user may use their finger to press a graphical “down” button (not shown) to cause the protein column 112 to scroll down, or the user may use a mouse, for example, to click on a graphical “down” button (not shown) to cause the protein column 112 to scroll down. In some examples, the protein column 112 may be individually scrollable. For example, if the user scrolls down on the protein column 112, the protein column 112 may scroll down, but any other column (such as sauce column 116) or other image not included in the protein column 112 may remain unaffected (i.e., it may not scroll down). This may allow the user to individually scroll each column in graphical image 100.

The images 120 in the protein column 112 may have a static image size (e.g., a size that does not change). In such an example, as the protein column 112 (and the images 120 included within protein column 112) is scrolled, all of the images 120 within the protein column 112 may remain the same size. Alternatively, the images 120 in the protein column 112 may have a dynamic image size (e.g., a size that changes). In such an example, as the protein column 112 (and the images 120 included within protein column 112) is scrolled, a current image 120 (or a top-most image 120) may be enlarged in comparison to the other images 120.

Each image 120 within the protein column 112 may be selectable. By selecting the image 120, the protein cooking recipe associated with that image 120 (e.g., the blackened salmon recipe associated with the blackened salmon image 120a) may be selected as the selected protein cooking recipe. This may cause the selected protein cooking recipe to be added to the selected protein cooking recipe area 104 discussed above. Additional details regarding this are discussed below. The image 120 may be selected in any manner. For example, the user may use their finger to press on the image 120 (e.g., on a touch activated screen), causing it to be selected. As another example, the user may use a mouse, for example, to press on the image 120.

Graphical image 100 further includes a sauce column 116. Sauce column 116 may refer to an area in the graphical image 100 that may be used to display one or more sauce cooking recipes that can be selected by the user. Sauce column 116 may have any size and/or shape. Furthermore, sauce column 116 may include any number of sauce cooking recipes that can be selected by the user. For example, sauce column 116 may include one sauce cooking recipe, two sauce cooking recipes, 10 sauce cooking recipes, 100 sauce cooking recipes, 1000 sauce cooking recipes, or any other number of sauce cooking recipes. Additionally, although sauce column 116 is referred to as a column, it may be any array of sauce cooking recipes or any other arrangement of sauce cooking recipes. For example, the sauce column 116 may be a vertical array of sauce cooking recipes (e.g., a column, as is illustrated in FIG. 2), a horizontal/lateral array of sauce cooking recipes (e.g., a row), a circular array of sauce cooking recipes (e.g., a circular column, a circular row), any other type of array of sauce cooking recipes, or any other arrangement of sauce cooking recipes. As another example, each cooking recipe may be included on a different graphical image 100. As a further example, the sauce column 116 may be a textual list of sauce cooking recipes. As another example, the sauce column 116 may be a selectable menu that presents one or more cooking recipes in a selectable list, or in selectable subcategories (e.g., cold sauces, hot sauces).

Sauce column 116 may include sauce cooking recipes in any manner. As an example, sauce column 116 may include sauce cooking recipes by including a list of names associated with the sauce cooking recipes, a list of images associated with the sauce cooking recipes, any other manner of identifying the sauce cooking recipes for the user, or any combination of the preceding. As is illustrated, sauce column 116 includes images associated with the sauce cooking recipes. These images are illustrated as sauce images 124 (e.g., 124a, 124b, and 124c). The image associated with the sauce cooking recipe may be any image that may identify the sauce cooking recipe for the user. For example, the image may be a photograph of the end result of the sauce cooking recipe, a drawing of the end result of the sauce cooking recipe, any other illustration that may identify the sauce cooking recipe for the user, or any combination of the preceding. As is illustrated, the images 124 included in the sauce column 116 include a photograph of the end result of each the sauce cooking recipes (e.g., the image for a sauce cooking recipe for bacon emulsion is a photograph of all or a portion of the fully (or partially) cooked/prepared bacon emulsion). Furthermore, the images 120 also include a name associated with each the sauce cooking recipes (e.g., the image for bacon emulsion includes the name “Bacon Emulsion”). The name may be superimposed on the photograph, as is illustrated in FIG. 2.

The images 124 may be included within the sauce column 116 in any manner. For example, as is illustrated, each image 124 may be included within the sauce column 116 so as to be side-by-side (such as vertically side-by-side) with a subsequent image 124. The images 124 may be included in any order within the sauce column 116. For example, the images 124 may be included in alphabetical order, popularity order (with the most popular cooking recipes being listed first), user popularity order (with the particular user's most popular cooking recipes being listed first), order of storage, order of loading on the graphical image 100, any other order, or any combination of the preceding.

Sauce column 116 (and the images 124 included within sauce column 116) may be scrollable. For example, even though only two images 124 (124a and 124b) are fully shown in FIG. 2, the user may scroll down (or up) in order to be presented with additional images 124. This may allow the user to scroll through any number of images 124 included within the sauce column 116. The user may scroll through the images 124 in any manner. For example, a user may flick (or slide) their finger upward on the screen (e.g., a touch activated screen) and over the images 124 so as to cause the sauce column 116 to scroll down and show additional images 124. As another example, the user may use their finger to press a graphical “down” button (not shown) to cause the sauce column 116 to scroll down, or the user may use a mouse, for example, to click on a graphical “down” button (not shown) to cause the sauce column 116 to scroll down. In some examples, the sauce column 116 may be individually scrollable. For example, if the user scrolls down on the sauce column 116, the sauce column 116 may scroll down, but any other column (such as protein column 112) and any other image not included in the sauce column may remain unaffected (i.e., it may not scroll down). This may allow the user to individually scroll each column in graphical image 100.

The images 124 in the sauce column 116 may have a static image size (e.g., a size that does not change). In such an example, as the sauce column 116 (and the images 124 included within sauce column 116) is scrolled, all of the images 124 within the sauce column 116 may remain the same size. Alternatively, the images 124 in the sauce column 116 may have a dynamic image size (e.g., a size that changes). In such an example, as the sauce column 116 (and the images 124 included within sauce column 116) is scrolled, a current image 124 (or a top-most image 124) may be enlarged in comparison to the other images 124.

Each image 124 within the sauce column 116 may be selectable. By selecting the image 124, the sauce cooking recipe associated with that image 124 (e.g., the bacon emulsion recipe associated with the bacon emulsion image 124a) may be selected as the selected sauce cooking recipe. This may cause the selected sauce cooking recipe to be added to the selected sauce cooking recipe area 108 discussed above. Additional details regarding this are discussed below. The image 124 may be selected in any manner. For example, the user may use their finger to press on the image 124, causing it to be selected. As another example, the user may use a mouse, for example, to press on the image 124.

Graphical image 100 further includes protein filter 128. Protein filter 128 may refer to a selectable filter that allows the user to filter the types of protein cooking recipes that are included within the protein column 112. For example, the protein filter 128 may allow the user to cause protein column 112 to only include protein cooking recipes for chicken, for example. As another example, the protein filter 128 may allow the user to cause protein column 112 to only include protein cooking recipes for American food. Other examples of the type of filters that may be applied using protein filter 128 may include: protein category (e.g., chicken, seafood, lamb, poultry, beef, pork, vegetable, fish, etc.), cuisine type (e.g., American, Spanish, Latin American, Middle Eastern, Southern, Mediterranean), cooking time (e.g., 30 minutes or less, one hour or less), calorie amount, cooking style (e.g., fried, blackened, grilled), any other filter, or any combination of the preceding. By utilizing the protein filter 128, the user may be able to narrow down their choices of cooking recipes. This may allow the user to more easily find the cooking recipe they are looking for.

Graphical image 100 further includes sauce filter 132. Sauce filter 132 may refer to a selectable filter that allows the user to filter the types of sauce cooking recipes that are included within the sauce column 116. For example, the sauce filter 132 may allow the user to cause sauce column 116 to only include sauce cooking recipes that include cheese, for example. As another example, the sauce filter 132 may allow the user to cause sauce column 116 to only include sauce cooking recipes for American food. Other examples of the type of filters that may be applied using sauce filter 132 may include: sauce spice category (e.g., spicy, not-spicy), cuisine type (e.g., American, Spanish, Latin American, Middle Eastern, Southern, Mediterranean), cooking time (e.g., 30 minutes or less, one hour or less), calorie amount, cooking style (e.g., cooked, raw), any other filter, or any combination of the preceding. By utilizing the sauce filter 132, the user may be able to narrow down their choices of cooking recipes. This may allow the user to more easily find the cooking recipe they are looking for.

In some examples, for the protein filter 128 and/or the sauce filter 132 to function, cooking information 34 may include an association between filter types and the cooking recipes. For example, the cooking information 34 may include an identifier that associates particular cooking recipes with a particular filter. As such, when a particular filter is selected (e.g., chicken), the computing device 14 may search the cooking information 34 for all cooking recipes that have (or that are identified by) an identifier for the particular filter (e.g., a chicken identifier). In other examples, cooking information 34 may have any other storage mechanism or organization that allows a searchable or accessible association between a particular filter type and cooking recipes (so as to allow the computing device 14 to determine which cooking recipes are associated with a particular filter type).

In some examples, graphical image 100 (and any of the other graphical images discussed herein) may be generated by the computing device 14 based on cooking information 34 that is stored on the computing device 14, cooking information 34 that is stored on the database 42, or any combination of the preceding. If the computing device 14 determines that some of the requested cooking information 34 is not stored on the computing device 14, the computing device 14 may communicate with the database 42 over network 38 in order to retrieve the requested cooking information 34.

Prior to the transmittal of the graphical image 100 for display to the user, the computing device 14 may determine which protein cooking recipes the graphical image 100 will display in protein column 112, and which sauce cooking recipes the graphical image 100 will display in sauce column 116. The computing device 14 may make such determinations in any manner. For example, the computing device 14 may search for (or otherwise retrieve) all protein cooking recipes (and sauce cooking recipes) included in cooking information 34, and may include all of these in the graphical image 100. As another example, the computing device 14 may only search for protein cooking recipes (and sauce cooking recipes) stored on the computing device 14 (or stored on the database 42), and may include only these in the graphical image 100. As a further example, the computing device 14 may only search for protein cooking recipes (and sauce cooking recipes) that have been previously selected for cooking by the user, that have been selected as a favorite by the user, or that have been recommended for cooking (e.g., recommended by a celebrity chef or a social media group), and then the computing device 14 may then include only these in the graphical image 100.

In order to include the protein cooking recipes and sauce cooking recipes in the graphical image 100, the computing device 14 may also determine which images 120 and images 124 to include in the graphical image 100. The computing device 14 may make such determinations in any manner. For example, after the computing device 14 has determined which protein cooking recipes to include in the graphical image 100, the computing device 14 may then search for (or otherwise retrieve) an associated image 120 for each determined protein cooking recipe. In such an example, the associated image 120 may be stored with (or in relation to) the determined protein cooking recipe, or the associated image 120 may include an identifier that associates it with the determined protein cooking recipe, or the determined protein cooking recipe may include an identifier that includes the location of the associated image 120.

In other examples, the computing device 14 may not determine protein cooking recipes and sauce cooking recipes prior to determining which images 120 and images 124 to include in the graphical image 100. In such examples, the computing device 14 may only search for images 120 and images 124 (without having to search for or determine the associated cooking recipes). To do so, the computing device 14 may search for (or otherwise retrieve) all images 120 and images 124 that are both included in cooking information 34 and that are also associated with protein cooking recipes and sauce cooking recipes. Then the computing device 14 may include these in the graphical image 100. As other examples, the computing device 14 may search for images 120 and images 124 in any of the other manners discussed above, and then may include the determined images 120 and images 124 in the graphical image 100 for transmittal for display to the user.

Following transmittal of the graphical image 100 for display to the user, the computing device 14 may receive an indication that the user has selected a particular protein cooking recipe. For example, the computing device 14 may receive an indication that the user has selected a particular image 120 that is associated with a particular protein cooking recipe (e.g., the user has selected the image for blackened salmon, which is associated with the protein cooking recipe for blackened salmon). The indication may be received in any manner. For example as is discussed above, the indication may be received by the user using their finger to press on the image 120, or the user may use a mouse to click on the image 120.

Following receipt of the indication, the computing device 14 may generate and transmit a second graphical image for display to the user. The second graphical image may be displayed on the screen of the computing device 14, or in some examples, may be displayed on any other screen or device in communication with the computing device 14. An example of the second graphical image is illustrated in FIG. 3 as graphical image 200.

The computing device 14 may transmit the second graphical image 200 as an entirely new graphical image, or the computing device 14 may transmit the second graphical image 200 in a manner that causes the first graphical image 100 (of FIG. 2) to be updated (or refreshed) to include the information of second graphical image 200.

Second graphical image 200 may be similar to first graphical image 100. For example, second graphical image 200 may have area 104, area 108, protein column 112, sauce column 116, protein filter 128, and sauce filter 132. Additionally, the protein column 112 may have the same protein images 120 as are included in the protein column 112 of the first graphical image 100.

Unlike first graphical image 100, second graphical image 200 may include an image of the selected protein cooking recipe displayed in area 104. An example of this is seen in FIG. 3 as selected protein image 136. Selected protein image 136 may be any image that may identify the protein cooking recipe selected by the user. For example, the selected protein image 136 may be a photograph of the end result of the protein cooking recipe, a drawing of the end result of the protein cooking recipe, any other illustration that may identify the protein cooking recipe selected by the user, or any combination of the preceding. As is illustrated, selected protein image 136 includes a photograph of the end result of the protein cooking recipe (e.g., the image for a protein cooking recipe for pan seared snapper is a photograph of all or a portion of the fully (or partially) cooked/prepared pan seared snapper). Furthermore, the selected protein image 136 also includes the name associated with the protein cooking recipe (e.g., the image for pan seared snapper includes the name “Pan Seared Snapper”). The name may be superimposed on the photograph, as is illustrated in FIG. 3.

The selected protein image 136 may be the same, or may be different than the image 120 of the selected protein cooking recipe. For example, the selected protein image 136 for pan seared snapper may be identical to the image 120 for pan seared snapper included within the protein column 112. On the other hand, the selected protein image 136 for pan seared snapper may be different than the image 120 for pan seared snapper included within the protein column 112. As is illustrated in FIG. 3, the selected protein image 136 and the image 120 for pan seared snapper are different. In particular, the selected protein image 136 includes a different photograph of the pan seared snapper. Additionally, the photograph used for the selected protein image 136 is magnified (or is a closer-up picture). Also, the font used for the name associated with the protein cooking recipe (e.g., “Pan Seared Snapper”) is larger than that in image 120. Also, in some examples, the name may be in a different font type, or a different font color, or the name may be a different style (e.g., bolded, italicized). Also, the selected protein image 136 may be larger (e.g., 3″×2.5″) than the image 120 (e.g., 1.5″×2.5″).

In some examples, the differences between selected protein image 136 and image 120 (e.g., the larger image and larger font of the selected protein image 136), and/or the position of the selected protein image 136 (e.g., a location set aside from the protein column 112) may make viewing the selected protein image 136 easier for the user (and may also make it easier to share the selected protein image 136 with dining companions), as the selected protein image 136 may stand out from the images 120 in the protein column 112. These differences may help the user comprehend that the selected protein image 136 is the selected protein cooking recipe. As such, there may be less of a likelihood that the user may mistake selected protein image 136 for one of the images 120 (or vice versa). Also, the location and view ability of the selected protein image 136 may not be affected by any subsequent scrolling of the protein column 112 and/or sauce column 116. Thus, the user can more easily look for alternative cooking recipes, while the current selected protein image 136 may remain easily viewable, in some examples.

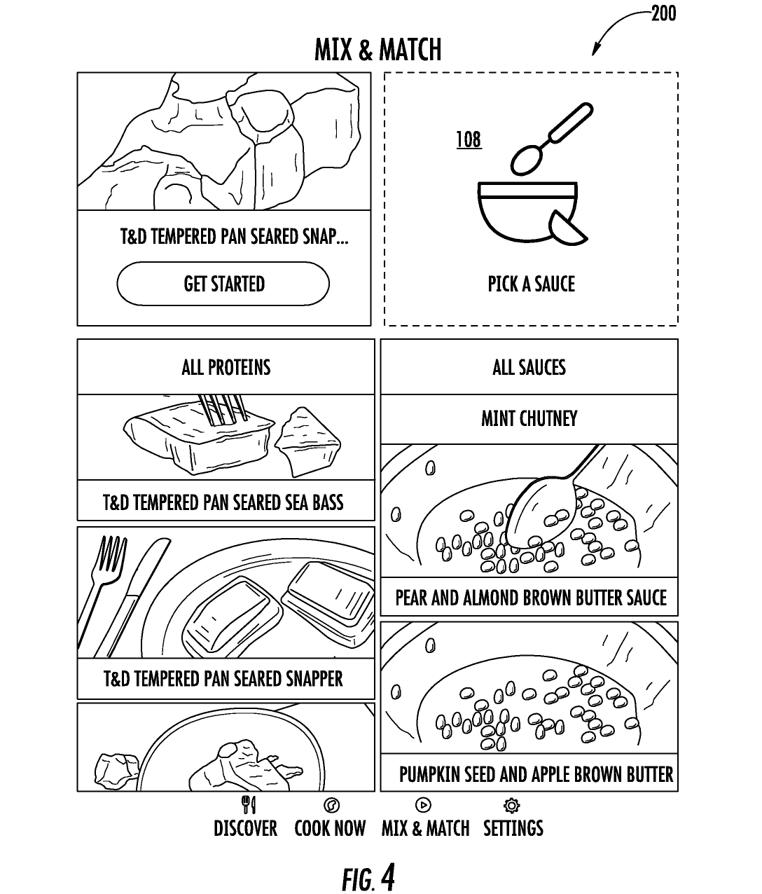

Although second graphical image 200 illustrates pan seared snapper as being the selected protein cooking recipe, second graphical image 200 may also allow the user to change the selection. For example, the user may be able to press down on the selected protein image 136 for a particular amount of time (such as 2 seconds), causing the selected protein image 136 to be unselected. This may cause the selected protein image 136 to disappear. When this occurs, the user may be able to select a different protein cooking recipe by scrolling through the images 120 in the protein cooking column 112, and selecting a different image 120. In another example, the user may be able to change the selection by merely scrolling through the images 120 in the protein cooking column 112, and selecting a different image 120. This may cause the selected protein image 136 of pan seared snapper to be replaced by a different selected protein image 136 of, for example, “T&D Tempered Pan Seared Snapper,” as is illustrated in FIG. 4.

Furthermore, although a user may scroll through the images 120 in protein column 112 and/or the images 124 in sauce column 116, this scrolling may not affect the placement of selected protein image 136. Instead, selected protein image 136 may remain in the same location (e.g., at the top of the second graphical image 200, above the column 112) and remain visible to the user. This may allow the user to continue to scroll through the cooking recipe options, while still being able to view what cooking recipes are currently selected.

As is also illustrated, the selected protein image 136 may further include a selectable button (e.g., the button “Get Started”) that may allow the user to go forward with cooking just the selected protein cooking recipe. When this button is activated by the user (such as by the user pressing on the button with their finger or using a mouse), electronic cookbook 30 may go forward with assisting the user in cooking only the selected protein cooking recipe. That is, the user may not be required to pick a sauce cooking recipe.

The second graphical image 200 may also include different content in its sauce column 116 than does the first graphical image 100. In particular, although the sauce column 116 of the first graphical image 100 and the sauce column 116 of the second graphical image 200 may both include sauce cooking recipes, in some examples, the sauce column 116 of the second graphical image 200 may include different sauce cooking recipes than the first graphical image 100. As an example of this, the sauce column 116 of the first graphical image 100 may include, for example, 100 sauce cooking recipes, while the sauce column 116 of the second graphical image 200 may include a subset of that, such as, for example, only 25 sauce cooking recipes.

In some examples, the different sauce cooking recipes included in the second graphical image 200 may be based on the protein cooking recipe that was selected by the user. That is, the second graphical image 200 may only include sauce cooking recipes that are associated with the protein cooking recipe that was selected by the user. For example, the second graphical image 200 may only include sauce cooking recipes that have previously been determined (e.g., by the user, by a professional chef, by the electronic cookbook 30) to go well with the protein cooking recipe that was selected by the user. As an example this, it may have been previously determined that particular sauces (such as barbeque sauce, for example) may not go well with a particular protein cooking recipe (such as salmon, for example). In such an example, if the user selects salmon as its protein cooking recipe, the second graphical image 200 may not include barbecue sauces as possible sauce cooking recipes within its sauce column 116. In such an example, if these barbecue sauces were included in the sauce column 116 of the first graphical image 100, they may be removed from the sauce column 116 of the second graphical image 200. As an example of this, if the sauce column 116 of the first graphical image 100 includes sauce cooking recipes 1-10, the sauce column 116 of the second graphical image 200 may only include sauce cooking recipes 2, 5-7, and 9 (with sauce cooking recipes 1, 3-4, 8, and 10 having been removed from the sauce column 116 of the second graphical image 200). Furthermore, if these barbecue sauces were not included in the sauce column 116 of the first graphical image 100, they may still not be included in the sauce column 116 of the second graphical image 200. In other examples, the selection of particular protein cooking recipe may cause the second graphical image 200 to include one or more sauce cooking recipes that were not originally displayed in the first graphical image 100.

This narrowing down (or otherwise limiting or changing) of the displayed sauce cooking recipes may be triggered by the selection of a protein cooking recipe. Thus, the sauce cooking recipes displayed in sauce column 116 may be narrowed down (or otherwise changed) following the selection of a protein cooking recipe. In some examples, this ability to narrow down (or otherwise limit or change) the sauce cooking recipes may assist the user in selecting a more appropriate sauce to pair with the selected protein cooking recipe. As such, users with less experience in cooking may be prevented from selecting a sauce that may not go well with the selected protein cooking recipe, thereby assisting the user with their cooking.

In some examples, this ability to narrow down (or otherwise limit or change) the sauce cooking recipes based on a prior selection of a protein cooking recipe may speed up the operation of the computing device 14 (and/or electronic cookbook 30). For example, due to the narrowing down of the applicable sauce cooking recipes, the computing device 14 (and/or electronic cookbook 30) may have to load (or refresh) fewer sauce cooking recipes, which may lower the demand on the processor(s) 22 of the computing device 14. This may cause the computing device 14 to operate faster, as it may not be burdened with loading (or refreshing) sauce cooking recipes that are not applicable to the selected protein cooking recipe. Additionally, this also may speed up the process of creating later graphical images (discussed below). Specifically, because there are less possible sauce cooking recipes to choose from, the processor 22 may more easily and quickly find the recipe and images for the selected sauce cooking recipe (e.g., the processor only has to search through a subset of the sauce cooking recipes, as opposed to all possible sauce cooking recipes) when attempting to load the recipe and images for view by the user.

In some examples, in order for the narrowing down (or otherwise limiting or changing) of the displayed sauce cooking recipes to function, cooking information 34 may include an association between protein cooking recipes and the sauce cooking recipes. For example, the cooking information 34 may include an identifier that associates particular sauce cooking recipes with a particular protein cooking recipe. As such, when a particular protein cooking recipe is selected (e.g., grilled chicken), the computing device 14 may search the cooking information 34 for all cooking recipes that have (or that are identified by) an identifier for the particular protein cooking recipe (e.g., a grilled chicken identifier). In other examples, cooking information 34 may have any other storage mechanism or organization that allows a searchable or accessible association between a particular protein cooking recipe and sauce cooking recipes (so as to allow the computing device to determine which sauce cooking recipes are associated with a particular protein cooking recipe).

To further assist the user, second graphical image 200 may also include sauce filter 132 (an example of which was discussed above). The sauce filter 132 may refer to a selectable filter that allows the user to filter the types of sauce cooking recipes that are included within the sauce column 116, such as to filter the sauce cooking recipes by: sauce spice category (e.g., spicy, not-spicy), cuisine type (e.g., American, Spanish, Latin American, Middle Eastern, Southern, Mediterranean), cooking time (e.g., 30 minutes or less, one hour or less), calorie amount, cooking style (e.g., cooked, raw), any other filter, or any combination of the preceding. By utilizing the sauce filter 132, the user may be able to further narrow down their choices of sauce cooking recipes. Such filtering may be in addition to any filtering that has already been performed based on the selected protein cooking recipe. For example, as is discussed above, if the selected protein cooking recipe has narrowed the number of sauce cooking recipes included in sauce column 116 from sauce cooking recipes 1-10 to sauce cooking recipes 2, 5-7, and 9, the sauce filter 132 may further narrow this number of sauce cooking recipes to only include recipes that are, for example, of the Latin American cuisine type, such as only sauce cooking recipes 2 and 9.

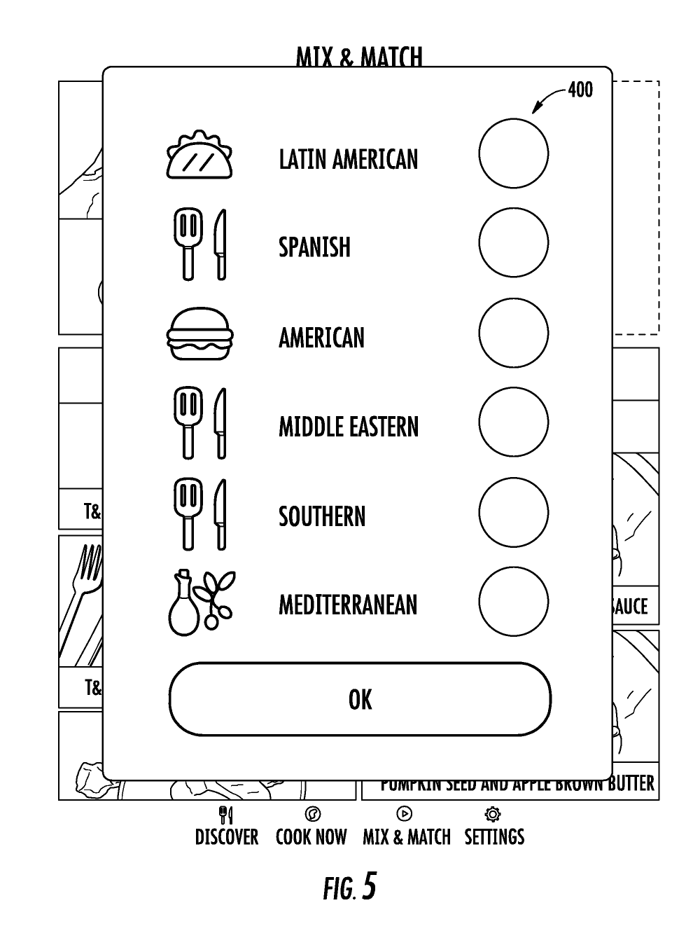

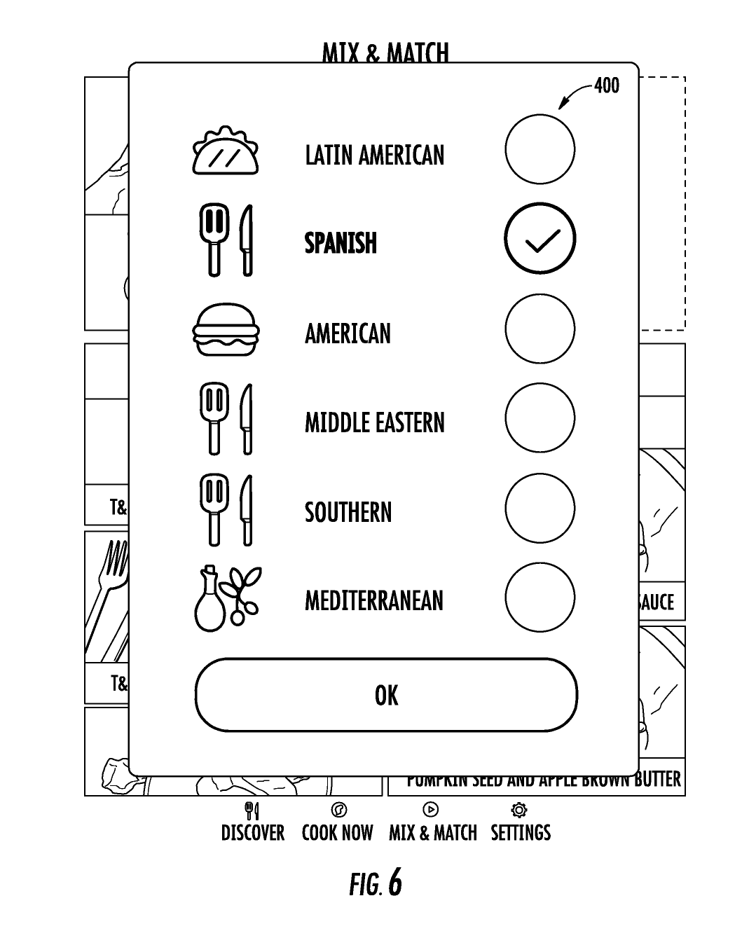

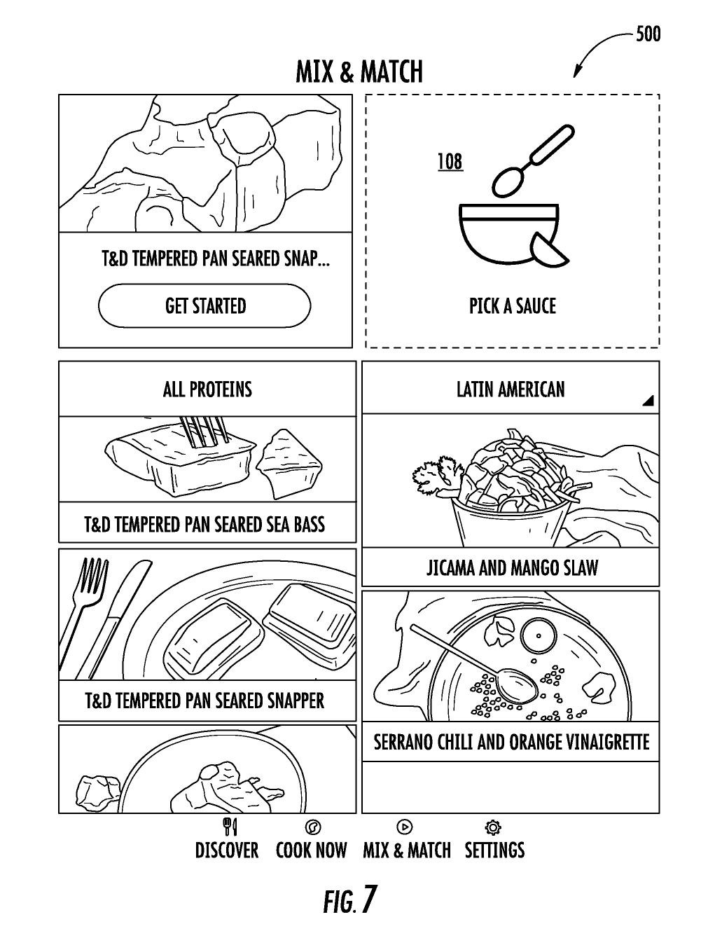

FIG. 5 illustrates an example of a filter graphical image 400 that may be generated and transmitted for display over (or instead of) the second graphical image 200 (or first graphical image 100) when a user activates the sauce filter 132 (or the protein filter 128). FIG. 6 illustrates an example of the filter graphical image 400 being updated to include a selection of a particular filter (i.e., Spanish cuisine type). FIG. 7 illustrates an example of an updated second graphical image 500 that may be transmitted for display (to replace or refresh the second graphical image 200). As is illustrated, the selected filter is “Latin American” cuisine type, and the sauce column 116 has been updated to include, for example, 2 sauce cooking recipes that have been predetermined to go with the selected protein cooking recipe (e.g., T&D Tempered Pan Seared Snapper) and also with the selected sauce filter (e.g., Latin American cuisine type).

Prior to the transmittal of the second graphical image 200 for display to the user, the computing device 14 may determine which sauce cooking recipes the second graphical image 200 will display in sauce column 116. The computing device 14 may make such determinations in any manner. For example, as is discussed above, the cooking information 34 may include an association between protein cooking recipes and sauce cooking recipes (e.g., an identifier that associates particular sauce cooking recipes with a particular protein cooking recipe). In such an example, when a particular protein cooking recipe is selected (e.g., grilled chicken), the computing device 14 may search for (or otherwise retrieve) all sauce cooking recipes that are both included in the cooking information 34 and that are also associated with the selected protein cooking recipe (e.g., sauce cooking recipes that have or that are identified by an identifier for the selected grilled chicken cooking recipe). The computing device 14 may then include only these in the second graphical image 200. As another example, the computing device 14 may search for all sauce cooking recipes that are both included in the original graphical image 100 and that are also associated with the selected protein cooking recipe. The computing device 14 may then include only these in the second graphical image 200.

In order to include the sauce cooking recipes in the second graphical image 200, the computing device 14 may also determine which images 124 to include in the second graphical image 200. The computing device 14 may make such determinations in any manner. For example, after the computing device 14 has determined which sauce cooking recipes to include in the second graphical image 200, the computing device 14 may then search for (or otherwise retrieve) an associated image 124 for each determined sauce cooking recipe. In such an example, the associated image 124 may be stored with (or in relation to) the determined sauce cooking recipe, or the associated image 124 may include an identifier that associates it with the determined sauce cooking recipe, or the determined sauce cooking recipe may include an identifier that includes the location of the associated image 124.

In other examples, the computing device 14 may not determine sauce cooking recipes prior to determining which images 124 to include in the second graphical image 200. In such examples, the cooking information 34 may include an association between images 120 and images 124 (e.g., an identifier that associates particular images 124 with a particular image 120). In such an example, when a particular image 120 is selected (e.g., an image for grilled chicken), the computing device 14 may search for (or otherwise retrieve) all images 124 that are both included in the cooking information 34 and that are also associated with the selected image 120 (e.g., sauce images 124 that have or that are identified by an identifier for the selected protein image 120). The computing device 14 may then include only these in the second graphical image 200. As another example, the computing device 14 may search for all images 124 that are both included in the original graphical image 100 and that are also associated with the selected image 120. The computing device 14 may then include only these in the second graphical image 200.

Following transmittal of the second graphical image 200 for display to the user, the computing device 14 may receive an indication that the user has selected a particular sauce cooking recipe. For example, the computing device 14 may receive an indication that the user has selected a particular image 124 that is associated with a particular sauce cooking recipe (e.g., the user has selected the image for serrano chili and orange vinaigrette, which is associated with the sauce cooking recipe for serrano chili and orange vinaigrette). The indication may be received in any manner. For example, as is discussed above, the indication may be received by the user using their finger to press on the image 124, or the user may use a mouse to click on the image 124.

Following receipt of the indication, the computing device 14 may generate and transmit a third graphical image for display to the user. The third graphical image may be displayed on the screen of the computing device 14, or in some examples, may be displayed on any other screen or device in communication with the computing device 14. An example of the third graphical image is illustrated in FIG. 8 as third graphical image 600.

Third graphical image 600 may be similar to second graphical image 200. For example, third graphical image 600 may have area 104, area 108, protein column 112, sauce column 116, protein filter 128, and sauce filter 132. Additionally, the protein column 112 may have the same images 120 as are included in the protein column 112 of the second graphical image 200, and the sauce column 116 may have the same images 124 as are included in the sauce column 116 of the second graphical image 200. Furthermore, the area 104 of the third graphical image 600 may include the same image 136 of the selected protein cooking recipe (e.g., both may include the same photograph of T&D Tempered Pan Seared Snapper).

Unlike second graphical image 200, third graphical image 600 may include an image of the selected sauce cooking recipe displayed in area 108. An example of this is seen in FIG. 8 as selected sauce image 140. Selected sauce image 140 may be any image that may identify the sauce cooking recipe selected by the user. For example, the selected sauce image 140 may be a photograph of the end result of the sauce cooking recipe, a drawing of the end result of the sauce cooking recipe, any other illustration that may identify the sauce cooking recipe selected by the user, or any combination of the preceding. As is illustrated, selected sauce image 140 includes a photograph of the end result of the sauce cooking recipe (e.g., the image for a sauce cooking recipe for serrano chili and orange vinaigrette is a photograph of all or a portion of the fully (or partially) cooked/prepared serrano chili and orange vinaigrette). Furthermore, the selected sauce image 140 also include the name associated with the sauce cooking recipe (e.g., the image for serrano chili and orange vinaigrette includes the name “Serrano Chili and Orange Vinaigrette”). The name may be superimposed on only the image for the selected sauce cooking recipe. As another example, the name may be superimposed on both the image for the selected protein cooking recipe and the image for the selected sauce cooking recipe, as is illustrated in FIG. 8.

The selected sauce image 140 may be the same, or may be different than the image 124 for the sauce cooking recipe. For example, the selected sauce image 140 for serrano chili and orange vinaigrette may be identical to the image 124 for serrano chili and orange vinaigrette included within the sauce column 116. On the other hand, the selected sauce image 140 for serrano chili and orange vinaigrette may be different than the image 124 for serrano chili and orange vinaigrette included within the sauce column 116. As is illustrated in FIG. 8, the selected sauce image 140 and the image 124 for serrano chili and orange vinaigrette are different in that the photograph used for the selected sauce image 140 is magnified (or is a closer-up picture). Also, the font used for the name associated with the sauce cooking recipe (e.g., “serrano chili and orange vinaigrette”) may be larger than that in image 124, or the name may be in a different font type, or a different font color, or the name may be in a different style (e.g., bolded, italicized). Also, the selected sauce image 140 may be larger (e.g., 3″×2.5″) than the image 124 (e.g., 1.5″×2.5″)

In some examples, the difference(s) between the selected sauce image 140 and the image 124 (e.g., the larger image and larger font of the selected sauce image 140), and/or the position of the selected sauce image 140 (e.g., a location set aside from the sauce column 116) may make viewing the selected sauce image 140 easier for the user (and may also make it easier to share the selected sauce image 140 with dining companions), as the selected sauce image 140 may stand out from the images 124 in the sauce column 116. These differences between selected sauce image 140 and image 124 may help the user comprehend that the selected sauce image 140 is the selected sauce cooking recipe. As such, there may be a less likelihood that the user may mistake selected sauce image 140 for one of the images 124 (or vice versa). Also, the location and view ability of the selected sauce image 140 may not be affected by any subsequent scrolling of the protein column 112 and/or sauce column 116. Thus, the user can more easily look for alternative cooking recipes, while the current selected sauce image 140 may remain easily viewable, in some examples.

Although third graphical image 600 illustrates pan seared snapper as being the selected protein cooking recipe and serrano chili and orange vinaigrette as being the selected sauce cooking recipe, third graphical image 600 may also allow the user to change one or both of these selections. For example, the user may be able to press down on the selected sauce image 140 for a particular amount of time (such as 2 seconds), causing the selected sauce image 140 to be unselected. This may cause the selected sauce image 140 to disappear. When this occurs, the user may be able to select a different sauce cooking recipe by scrolling through the images 124 in the sauce column 116, and selecting a different image 124. In another example, the user may be able to change the selection by merely scrolling through the images 124 in the sauce column 116, and selecting a different image 124. This may cause the selected sauce image 140 of serrano chili and orange vinaigrette to be replaced by a different selected sauce image 140 of, for example, Jicama and Mango slaw.

Furthermore, although a user may scroll through the images 120 in protein column 112 and/or the images 124 in sauce column 116, this scrolling may not affect the placement of selected protein image 136 and/or selected sauce image 140. Instead, selected protein image 136 and selected sauce image 140 may remain in the same location (e.g., at the top of the third graphical image 600, above the respective column 112, 116) and remain visible to the user. This may allow the user to continue to scroll through the cooking recipe options, while still being able to view what cooking recipes are currently selected.

As is also illustrated, the selected protein image 136 and selected sauce image 140 may further include a selectable button (e.g., a “Get Started” button) that may allow the user to go forward with cooking the selected recipes. When this button is activated by the user (such as by the user pressing on the button with their finger or using a mouse), electronic cookbook 30 may go forward with assisting the user in cooking both of the selected cooking recipes.

Following transmittal of the third graphical image 600 for display to the user, the computing device 14 may receive an indication that the user has selected to proceed (or otherwise go forward with) the selected protein cooking recipe and the selected sauce cooking recipe. For example, the computing device 14 may receive an indication that the user has selected the selectable button (e.g., “Get Started”) included in the selected protein image 136 and selected sauce image 140.

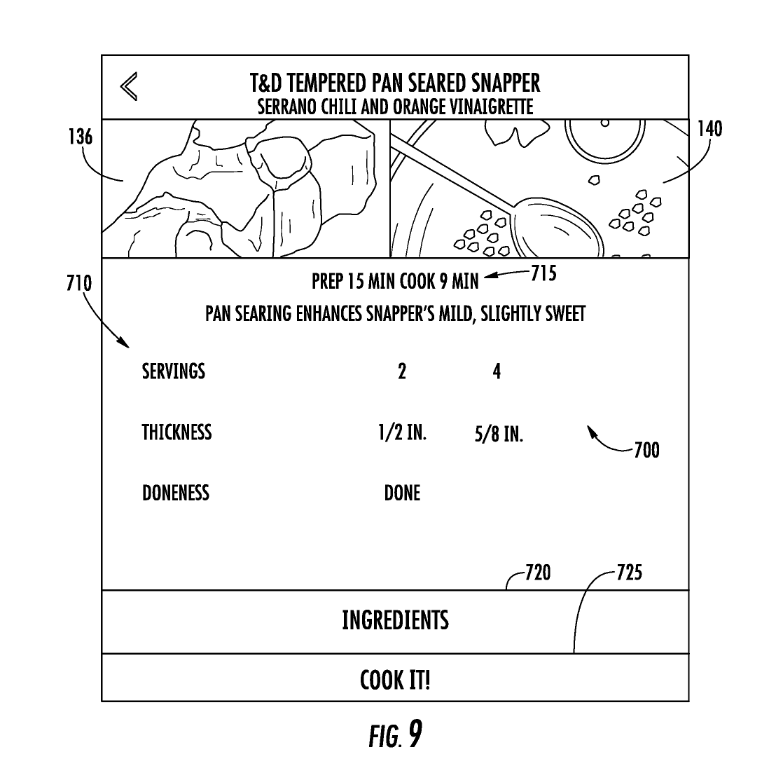

Following receipt of the indication, the computing device 14 may generate and transmit a fourth graphical image for display to the user. The fourth graphical image may be displayed on the screen of the computing device 14, or in some examples, may be displayed on any other screen or device in communication with the computing device 14. An example of the fourth graphical image is illustrated in FIG. 9 as fourth graphical image 700.

As is illustrated, fourth graphical image 700 may include the selected protein image 136 and the selected sauce image 140. Furthermore, fourth graphical image 700 may include cooking options 710. Cooking options 710 may include any type of option selectable by a user that may affect the cooking of the selected cooking recipes. Examples of cooking options 710 include serving size (e.g., 1 serving, 2 servings, 4 servings), size of ingredients (e.g., thickness of a steak of beef or filet of fish, such as ½″ or ⅝″), cooking doneness preference (e.g., done, rare, medium, well-done), any other option, or any combination of the preceding. Fourth graphical image 700 may allow a user to enter quantities associated with the cooking options 710. For example, if the user prefers to have their steak cooked medium-rare, fourth graphical image 700 may allow the user to enter such a preference. The user may enter the preference in any manner. For example, the user may select from two or more options displayed (or scrollable through) by the fourth graphical image 700. As another example, the user may enter the preference using a keyboard (e.g., such as typing in the size of a steak to be “⅝″”).

Based on a user's entry of one or more cooking options 710, fourth graphical image 700 may be updated to include a more accurate estimated cook time 715. For example, if the user enters a cooking doneness preference of well done (as opposed to the pre-entered recommended medium or medium-rare), the fourth graphical image 700 may be updated to include a longer estimated cook time 715, such as by increasing the amount of cook time.

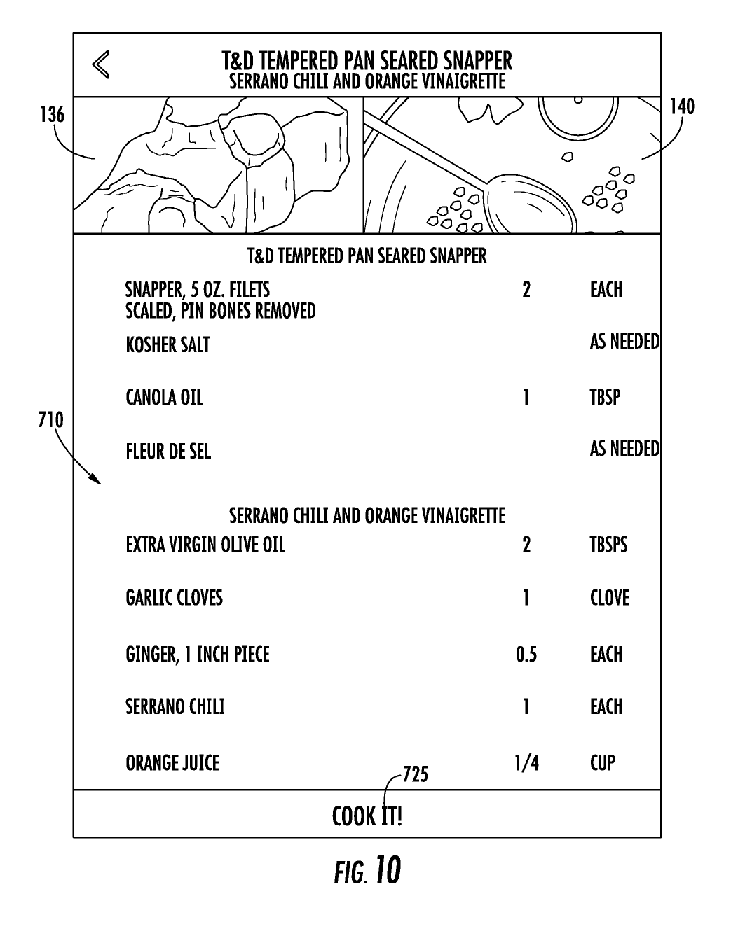

As is also illustrated, fourth graphical image 700 may also include a first selectable button 720 (e.g., ingredients) that may allow a user to view the ingredients that are needed for cooking the cooking recipes. When this button is activated by the user (such as by the user pressing on the button with their finger or using a mouse), computing device 14 may generate and transmit for display a fifth graphical image that includes a list of the ingredients. An example of the fifth graphical image is illustrated in FIG. 10 as fifth graphical image 800. This list may include a list of the ingredients and the quantities of the ingredients. In some examples, some ingredients may be selectable, which may allow the user to view and/or select substitute ingredients (e.g., dried minced onions may be substituted for fresh cut onions). Selection of substitute ingredients may cause the fifth graphical image 800 to be refreshed (or updated) to include an ingredient amount of the substitute ingredient. In some examples, the list of ingredients in fifth graphical image 800 may allow the user to gather the ingredients, confirm that they have the ingredients, add the ingredients to a shopping list (which may be automated by a selectable button included in the graphical image (not shown)), and/or use the fifth graphical image 800 as a shopping list.

Similar to that discussed above, prior to the transmittal of the fourth graphical image 700 and/or the fifth graphical image 800 for display to the user, the computing device 14 may determine the cooking options 710 and cook time 715 and/or may determine the ingredients. The computing device 14 may make such determinations in any manner. For example, as is discussed above, the cooking information 34 may include an association between cooking recipes and cooking options 710, cook times 715, and/or ingredients (e.g., an identifier that associates particular cooking options 710, cook times 715, and/or ingredients with particular cooking recipes). In such an example, when particular cooking recipes are selected, the computing device 14 may search for (or otherwise retrieve) these cooking options 710, cook times 715, and/or ingredients. Then the computing device 14 may include them in the fourth graphical image 700 and/or the fifth graphical image 800.

As is also illustrated, fourth graphical image 700 (of FIG. 9) and/or fifth graphical image 800 (of FIG. 10) may also include a second selectable button 725 (e.g., “Cook it!”). When this button is activated by the user (such as by the user pressing on the button with their finger or using a mouse), computing device 14 may generate and transmit for display one or more additional graphical images that may assist the user in cooking the selected cooking recipes. The one or more additional graphical images may include any information that may assist the user in cooking the selected cooking recipes. For example, the additional graphical image(s) may include the cooking recipes themselves, one or more steps needed to cook the cooking recipes, one or more images (photographs/drawings) that illustrate the steps needed to cook the cooking recipes or that illustrate the ingredients (such as a picture of an onion, a picture of a diced onion, a picture of what an onion looks like after being caramelized, etc.), one or more instruction videos that illustrate the steps need to cook the cooking recipes, nutritional information associated with the cooking recipes, a list of devices or appliances that may be used to cook the cooking recipes (such as a description and/or picture of a particular pot/pan, a description and/or picture of a particular type of appliance (such as an oven or grill) that should be used to cook the cooking recipe, etc.), time based cooking information (such as total cooking time of the recipe, remaining cooking time left in the recipe, elapsed time, time left until the cooking device reaches a particular cooking temperature, clock time at which cooking is expected to be completed, etc.), any other information that may assist the user in cooking the selected cooking recipes, or any combination of the preceding.

In some examples, the additional graphical image(s) may provide a step-by-step guide for cooking a food item in accordance with the selected cooking recipes. This step-by-step guide may navigate the user through each step in the cooking process. For example, the cooking recipe for fish may include the following steps: (1) clean the filet of fish; (2) add spices to the fish; (3) heat a cooking pan to medium; (4) add a tablespoon of olive oil to the pan; (5) add the filet of fish to the pan, skin side down, and cook for 4 minutes; (6) flip the filet of fish and cook for another 4 minutes; and (7) remove the fish from the pan and allow the filet to rest. The step-by-step guide may be provided on any number of additional cooking images. For example, each step may be included on its own additional cooking image. As another example, two or more steps may be included on a single additional cooking image. As a further example, all of the steps may be included on a single additional cooking image. As another example, a single step may be broken out between two or more additional cooking images.

In the step-by-step guide, each of the above example steps for fish may be displayed individually (or individually highlighted in the cooking recipe to identify the current step). For a current step, the computing device 14 may generate and transmit for display an additional graphical image that includes information that explains the current step in the cooking recipe, and further explains what the user is supposed to do during that step. Once the step has been completed, the user may be prompted to indicate that the step has been completed, such as by clicking on a “next” button displayed on the screen of the computing device 14. This may allow the user to navigate to the next step. The user may click on a button of the computing device 14 or on a graphical button included in the additional graphical image to activate such a “next” button. Additionally (or alternatively), the user may click on any other button (or control device) to navigate through the steps (or stages).

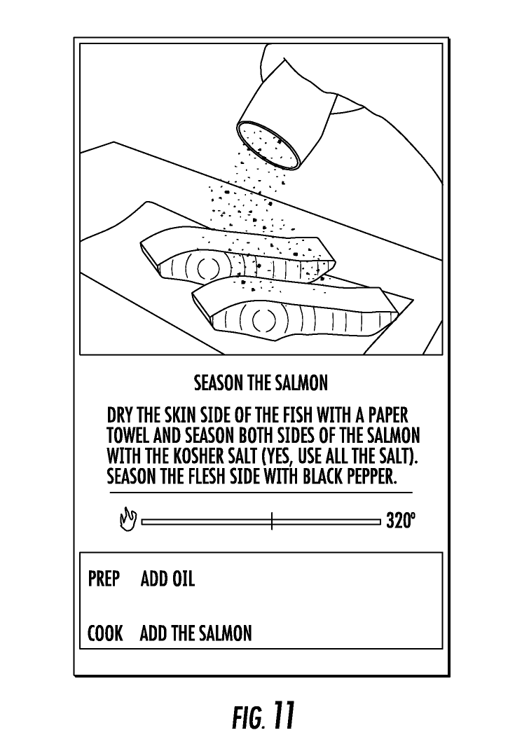

The step-by-step guide may further include additional information associated with cooking the food item. For example, if the third step for cooking fish is to heat a cooking pan to medium, the third step in the step-by-step guide may include pictures of the recommended cooking pan, pictures of the recommended heat source (such as a burner) that should be used to heat the pan, nutritional information associated with the fish, information about the type of fish that the fish meat comes from, instructional videos on how to handle the fish, instructional videos and/or other information associated with sanitizing your hands after touching the fish, other information associated with the particular step, or any combination of the preceding. Examples of the additional graphical images (and examples of the content of those images) are illustrated in FIGS. 11-15, with regard to an example where the selected protein cooking recipe is salmon and where the selected sauce cooking recipe is pumpkin seed and apple butter sauce.

In order to create the additional graphical image(s), the computing device 14 may merge the selected protein cooking recipe with the selected sauce cooking recipe so as to create a single recipe. In order to do so, the computing device 14 may retrieve each cooking recipe from the cooking information 34 (e.g., the computing device 14 may retrieve all of the cooking instructions and cooking information associated with each selected cooking recipe). Also, the computing device 14 may merge the two cooking recipes together in any manner. For example, the computing device 14 may merge the two cooking recipes together so that the first step of the second cooking recipe does not occur until after completion of all of the steps of the first cooking recipe. Such a merging of the two cooking recipes may be designed based on a preference of the user, or a preference of a chef that created the recipe. For example, the user may prefer to have the sauce cooked/prepared before the protein is cooked/prepared. As another example, the sauce may need to rest for a long period of time before it can be used with the protein.

As another example, the computing device 14 may merge the two cooking recipes together so that individual steps of each cooking recipe are mixed together. Such a merging of the two cooking recipes may be designed based on a preference of the user, or a preference of a chef that created the recipe. For example, the user may desire to have each of the recipes completed at substantially the same time. To do so, the computing device 14 may merge the individual steps together so as to cause both of the recipes to be completed at substantially the same time. In such an example, the user may complete a first step for the protein, followed by a first step of the sauce, followed by second step of the sauce, followed by second step of the protein, etc.

In some examples, the additional graphical image(s) may allow the user to fully cook/prepare both the selected protein cooking recipe and the selected sauce cooking recipe. When the user is done cooking/preparing each of the selected protein cooking recipe and the selected sauce cooking recipe, the user may de-activate the electronic cookbook 30 and/or the computing device 14.

Modifications, additions, and/or substitutions may be made to the exemplary embodiment of operation of cooking system 10 without departing from the scope of the specification. For example, instead of the user first selecting a protein cooking recipe, the user may alternatively first select a sauce cooking recipe. Such a selection may result in a narrowing (or limiting or changing) of the protein cooking recipes that are displayed in the protein column 112. In such an example, the protein column 112 may only display protein cooking recipes that are associated with the sauce cooking recipe that was selected by the user. As another example, the graphical images discussed above may include one or more navigation buttons (e.g., left and right buttons) that may allow a user to navigate through all (or a portion) of the graphical images.

As a further example, the computing device 14 may not transmit for display one or more of the example graphical images discussed above. For example, in some examples, the computing device 14 may not transmit for display fourth graphical image 700 (of FIG. 9) and/or fifth graphical image 800 (of FIG. 10). Instead, selection of the selectable button (e.g., a “Get Started” button) of the third graphical image 600 (of FIG. 8) may immediately start the cooking process by causing the computing device 14 to generate and transmit for display the step-by-step guide for cooking the cooking recipes (e.g., the step-by-step guide included in the one or more additional graphical images, such as those illustrated in FIGS. 11-15).

Furthermore, although the cooking system 10 has been described above as including particular components, functionalities, and/or abilities, the cooking system 10 (or one or more components of the cooking system 10) may further include one or more (or all) of the components, functionalities, and/or abilities described (and/or claimed) in U.S. Patent Application Publication No. 2016/0051078 entitled “Automated Cooking Control Via Enhanced Cooking Equipment” (which is incorporated herein by reference), and/or U.S. Patent Application Publication No. 2017/0238749 (which is also incorporated herein by reference). For example, as is discussed in U.S. Patent Application Publication No. 2017/0238749, the computing device 14 of cooking system 10 may further be able to communicate with (and/or activate and/or control) a heat source system and/or a cooking device system to assist the user in cooking a food item. In some examples, selectable buttons that allow (or cause) the computing device 14 to communicate with (and/or activate and/or control) the heat source system and/or the cooking device system may be included in the step-by-step cooking guide (or the additional cooking images). Such a selectable button may cause a heat source system to wirelessly turn on and begin heating, for example. As other examples, such communication between the computing device 14 and the heat source system and/or the cooking device system may allow temperatures associated with the cooking to be measured and transmitted to the computing device 14 for display. It may also allow the computing device 14 to wirelessly control the amount of heat provided by a heat source (such as a burner) of the heat source system so that the food item in the recipe is heated to a target temperature specified in the cooking recipe, for example.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification. In this manner, Applicant reserves the right to amend the claims during prosecution to add features as variously described in this specification.

What is claimed is:

1. A portable device, comprising:
a. one or more memory units operable to store one or more instructions; and:
b. one or more processors communicatively coupled to the one or more memory units and operable, when executing the one or more instructions, to:
i. determine a plurality of protein images, each of the plurality of protein images being associated with a respective protein cooking recipe;
ii. determine a plurality of sauce images, each of the plurality of sauce images being associated with a respective sauce cooking recipe;
iii. transmit for display a first graphical image that includes a first column for proteins and a second column for sauces, wherein the first column includes the plurality of protein images presented side-by-side in the first column, wherein the second column includes the plurality of sauce images presented side-by-side in the second column, wherein each of the plurality of protein images is selectable by a user, wherein each of the plurality of sauce images is selectable by the user, wherein the first graphical image is configured to separately scroll through each of the plurality of protein images in response to a request by the user, wherein the first graphical image is further configured to separately scroll through each of the plurality of sauce images in response to a request by the user;
iv. receive a first indication that the user has selected a first protein image of the plurality of protein images, wherein the first indication indicates that the user has selected the respective protein cooking recipe that is associated with the selected first protein image;
v. following the reception of the first indication:
a. determine, based on the selected protein cooking recipe, a subset of sauce images of the plurality of sauce images; and
b. transmit for display a second graphical image that includes a second protein image associated with the selected protein cooking recipe, and that further includes a first column for proteins and a second column for sauces, wherein the first column of the second graphical image includes the plurality of protein images presented side-by-side in the first column of the second graphical image, wherein the second column of the second graphical image includes the subset of sauce images presented side-by-side in the second column of the second column, wherein the second graphical image is configured to separately scroll through each of the plurality of protein images in response to a request by the user, wherein the second graphical image is further configured to separately scroll through each of the subset of sauce images in response to a request by the user;
c. receive a second indication that the user has selected a first sauce image of the subset of sauce images, wherein the second indication indicates that the user has selected the respective sauce cooking recipe that is associated with the selected first sauce image; and
vi. following the reception of the second indication:
a. transmit for display a third graphical image that includes the second protein image associated with the selected protein cooking recipe, and that further includes a second sauce image associated with the selected sauce cooking recipe, and that further includes a first column for proteins and a second column for sauces, wherein the first column of the third graphical image includes the plurality of protein images presented side-by-side in the first column of the third graphical image, wherein the second column includes the subset of sauce images presented side-by-side in the second column of the third graphical image, wherein the third graphical image is configured to separately scroll through each of the plurality of protein images in response to a request by the user, wherein the third graphical image is further configured to separately scroll through each of the subset of sauce images in response to a request by the user;
b. receive a third indication that the user has selected to proceed with the selected protein cooking recipe and the selected sauce cooking recipe;
vii. following reception of the third indication:
a. determine ingredients associated with the selected protein cooking recipe and the selected sauce cooking recipe;
b. transmit for display a fourth graphical image that includes the determined ingredients; and
c. receive a fourth indication that the user has selected to begin cooking the selected protein cooking recipe and the selected sauce cooking recipe; and
viii. following reception of the fourth indication, transmit for display a plurality of additional graphical images, wherein each of the plurality of additional graphical images includes one or more steps associated with cooking the selected protein cooking recipe and the selected sauce cooking recipe.

2. A portable device, comprising:
a. one or more memory units operable to store one or more instructions; and:
b. one or more processors communicatively coupled to the one or more memory units and operable, when executing the one or more instructions, to:
i. determine a plurality of first food images, each of the plurality of first food images being associated with a respective first cooking recipe of a plurality of first cooking recipes;
ii. determine a plurality of second food images, each of the plurality of second food images being associated with a respective second cooking recipe of a plurality of second cooking recipes;
iii. transmit for display a first graphical image that includes a first column and a second column, wherein the first column includes the plurality of first food images presented side-by-side in the first column, wherein the second column includes the plurality of second food images presented side-by-side in the second column, wherein each of the plurality of first food images is selectable by a user, wherein each of the plurality of second food images is selectable by the user, wherein the first graphical image is configured to separately scroll through each of the plurality of first food images in response to a request by the user, wherein the first graphical image is further configured to separately scroll through each of the plurality of second food images in response to a request by the user;
iv. receive a first indication that the user has selected a particular first food image of the plurality of first food images, wherein the first indication indicates that the user has selected the respective first cooking recipe that is associated with the selected first food image;
v. following the reception of the first indication:
1. determine, based on the selected first cooking recipe, a subset of second food images of the plurality of second food images; and
2. transmit for display a second graphical image that includes a third food image associated with the selected first cooking recipe, and that further includes a first column and a second column, wherein the first column of the second graphical image includes the plurality of first food images presented side-by-side in the first column of the second graphical image, wherein the second column of the second graphical image includes the subset of second food images presented side-by-side in the second column of the second column, wherein the second graphical image is configured to separately scroll through each of the plurality of first food images in response to a request by the user, wherein the second graphical image is further configured to separately scroll through each of the subset of second food images in response to a request by the user;
3. receive a second indication that the user has selected a particular second food image of the subset of second food images, wherein the second indication indicates that the user has selected the respective second cooking recipe that is associated with the selected second food image; and
vi. following the reception of the second indication, transmit for display a third graphical image that includes the third food image associated with the selected first cooking recipe, and that further includes a fourth food image associated with the selected second cooking recipe, and that further includes a first column and a second column, wherein the first column of the third graphical image includes the plurality of first food images presented side-by-side in the first column of the third graphical image, wherein the second column includes the subset of second food images presented side-by-side in the second column of the third graphical image, wherein the third graphical image is configured to separately scroll through each of the plurality of first food images in response to a request by the user, wherein the third graphical image is further configured to separately scroll through each of the subset of second food images in response to a request by the user.

3. The portable device of claim 2, wherein the one or more processors are further operable, when executing the one or more instructions, to:
a. receive a third indication that the user has selected to proceed with the selected first cooking recipe and the selected second cooking recipe;
b. following reception of the third indication:
i. determine ingredients associated with the selected first cooking recipe and the selected second cooking recipe;
ii. transmit for display a fourth graphical image that includes the determined ingredients; and
iii. receive a fourth indication that the user has selected to begin cooking the selected first cooking recipe and the selected second cooking recipe; and
c. following reception of the fourth indication, transmit for display a plurality of additional graphical images, wherein each of the plurality of additional graphical images includes one or more steps associated with cooking the selected first cooking recipe and the selected second cooking recipe.

4. The portable device of claim 2, wherein the one or more processors are further operable, when executing the one or more instructions, to:
a. receive a third indication that the user has selected to proceed with the selected first cooking recipe and the selected second cooking recipe; and
b. following reception of the third indication, transmit for display a plurality of additional graphical images, wherein each of the plurality of additional graphical images includes one or more steps associated with cooking the selected first cooking recipe and the selected second cooking recipe.

5. The portable device of claim 2, wherein the plurality of first cooking recipes is a plurality of main course cooking recipes, a plurality of beef cooking recipes, a plurality of fish cooking recipes, a plurality of tofu cooking recipes, or a plurality of protein cooking recipes.

6. The portable device of claim 5, wherein the plurality of second cooking recipes is a plurality of side dish cooking recipes, a plurality of dessert recipes, or a plurality of sauce cooking recipes.

7. The portable device of claim 2, wherein the subset of second food images comprises food images that are each associated with a respective second cooking recipe of a subset of the plurality of second cooking recipes, wherein each of the second cooking recipes of the subset of the plurality of second cooking recipes is associated with the selected first cooking recipe.

8. A method, comprising:
a. determining, by one or more processors, a plurality of first food images, each of the plurality of first food images being associated with a respective first cooking recipe of a plurality of first cooking recipes;
b. determining, by the one or more processors, a plurality of second food images, each of the plurality of second food images being associated with a respective second cooking recipe of a plurality of second cooking recipes;
c. transmitting, by the one or more processors, for display a first graphical image that includes a first column and a second column, wherein the first column includes the plurality of first food images presented side-by-side in the first column, wherein the second column includes the plurality of second food images presented side-by-side in the second column, wherein each of the plurality of first food images is selectable by a user, wherein each of the plurality of second food images is selectable by the user, wherein the first graphical image is configured to separately scroll through each of the plurality of first food images in response to a request by the user, wherein the first graphical image is further configured to separately scroll through each of the plurality of second food images in response to a request by the user;
d. receiving, by the one or more processors, a first indication that the user has selected a particular first food image of the plurality of first food images, wherein the first indication indicates that the user has selected the respective first cooking recipe that is associated with the selected first food image;
e. following the reception of the first indication:
i. determining, by the one or more processors and based on the selected first cooking recipe, a subset of second food images of the plurality of second food images; and
ii. transmitting, by the one or more processors, for display a second graphical image that includes a third food image associated with the selected first cooking recipe, and that further includes a first column and a second column, wherein the first column of the second graphical image includes the plurality of first food images presented side-by-side in the first column of the second graphical image, wherein the second column of the second graphical image includes the subset of second food images presented side-by-side in the second column of the second column, wherein the second graphical image is configured to separately scroll through each of the plurality of first food images in response to a request by the user, wherein the second graphical image is further configured to separately scroll through each of the subset of second food images in response to a request by the user; and
iii. receiving, by the one or more processors, a second indication that the user has selected a particular second food image of the subset of second food images, wherein the second indication indicates that the user has selected the respective second cooking recipe that is associated with the selected second food image; and
f. following the reception of the second indication, transmitting, by the one or more processors, for display a third graphical image that includes the third food image associated with the selected first cooking recipe, and that further includes a fourth food image associated with the selected second cooking recipe, and that further includes a first column and a second column, wherein the first column of the third graphical image includes the plurality of first food images presented side-by-side in the first column of the third graphical image, wherein the second column includes the subset of second food images presented side-by-side in the second column of the third graphical image, wherein the third graphical image is configured to separately scroll through each of the plurality of first food images in response to a request by the user, wherein the third graphical image is further configured to separately scroll through each of the subset of second food images in response to a request by the user.

9. The method of claim 8, further comprising:
a. receiving, by the one or more processors, a third indication that the user has selected to proceed with the selected first cooking recipe and the selected second cooking recipe;
b. following reception of the third indication:
i. determining, by the one or more processors, ingredients associated with the selected first cooking recipe and the selected second cooking recipe;
ii. transmitting, by the one or more processors, for display a fourth graphical image that includes the determined ingredients; and
iii. receiving, by the one or more processors, a fourth indication that the user has selected to begin cooking the selected first cooking recipe and the selected second cooking recipe; and
c. following reception of the fourth indication, transmitting, by the one or more processors, for display a plurality of additional graphical images, wherein each of the plurality of additional graphical images includes one or more steps associated with cooking the selected first cooking recipe and the selected second cooking recipe.

10. The method of claim 8, further comprising:
a. receiving, by the one or more processors, a third indication that the user has selected to proceed with the selected first cooking recipe and the selected second cooking recipe; and
b. following reception of the third indication, transmitting, by the one or more processors, for display a plurality of additional graphical images, wherein each of the plurality of additional graphical images includes one or more steps associated with cooking the selected first cooking recipe and the selected second cooking recipe.

11. The method of claim 8, wherein the plurality of first cooking recipes is a plurality of main course cooking recipes, a plurality of beef cooking recipes, a plurality of fish cooking recipes, a plurality of tofu cooking recipes, or a plurality of protein cooking recipes.

12. The method of claim 11, wherein the plurality of second cooking recipes is a plurality of side dish cooking recipes, a plurality of dessert recipes, or a plurality of sauce cooking recipes.

13. The method of claim 8, wherein the subset of second food images comprises food images that are each associated with a respective second cooking recipe of a subset of the plurality of second cooking recipes, wherein each of the second cooking recipes of the subset of the plurality of second cooking recipes is associated with the selected first cooking recipe.

14. A non-transitory computer readable medium comprising logic configured, when executed by one or more processors, to:
a. determine a plurality of first food images, each of the plurality of first food images being associated with a respective first cooking recipe of a plurality of first cooking recipes;
b. determine a plurality of second food images, each of the plurality of second food images being associated with a respective second cooking recipe of a plurality of second cooking recipes;
c. transmit for display a first graphical image that includes a first column and a second column, wherein the first column includes the plurality of first food images presented side-by-side in the first column, wherein the second column includes the plurality of second food images presented side-by-side in the second column, wherein each of the plurality of first food images is selectable by a user, wherein each of the plurality of second food images is selectable by the user, wherein the first graphical image is configured to separately scroll through each of the plurality of first food images in response to a request by the user, wherein the first graphical image is further configured to separately scroll through each of the plurality of second food images in response to a request by the user;
d. receive a first indication that the user has selected a particular first food image of the plurality of first food images, wherein the first indication indicates that the user has selected the respective first cooking recipe that is associated with the selected first food image;
e. following the reception of the first indication:
i. determine, based on the selected first cooking recipe, a subset of second food images of the plurality of second food images; and
ii. transmit for display a second graphical image that includes a third food image associated with the selected first cooking recipe, and that further includes a first column and a second column, wherein the first column of the second graphical image includes the plurality of first food images presented side-by-side in the first column of the second graphical image, wherein the second column of the second graphical image includes the subset of second food images presented side-by-side in the second column of the second column, wherein the second graphical image is configured to separately scroll through each of the plurality of first food images in response to a request by the user, wherein the second graphical image is further configured to separately scroll through each of the subset of second food images in response to a request by the user;
iii. receive a second indication that the user has selected a particular second food image of the subset of second food images, wherein the second indication indicates that the user has selected the respective second cooking recipe that is associated with the selected second food image; and
f. following the reception of the second indication, transmit for display a third graphical image that includes the third food image associated with the selected first cooking recipe, and that further includes a fourth food image associated with the selected second cooking recipe, and that further includes a first column and a second column, wherein the first column of the third graphical image includes the plurality of first food images presented side-by-side in the first column of the third graphical image, wherein the second column includes the subset of second food images presented side-by-side in the second column of the third graphical image, wherein the third graphical image is configured to separately scroll through each of the plurality of first food images in response to a request by the user, wherein the third graphical image is further configured to separately scroll through each of the subset of second food images in response to a request by the user.

15. The non-transitory computer readable medium of claim 14, wherein the logic is further configured, when executed by the one or more processors, to:
a. receive a third indication that the user has selected to proceed with the selected first cooking recipe and the selected second cooking recipe;
b. following reception of the third indication:
i. determine ingredients associated with the selected first cooking recipe and the selected second cooking recipe;
ii. transmit for display a fourth graphical image that includes the determined ingredients; and
iii. receive a fourth indication that the user has selected to begin cooking the selected first cooking recipe and the selected second cooking recipe; and
c. following reception of the fourth indication, transmit for display a plurality of additional graphical images, wherein each of the plurality of additional graphical images includes one or more steps associated with cooking the selected first cooking recipe and the selected second cooking recipe.

16. The non-transitory computer readable medium of claim 14, wherein the logic is further configured, when executed by the one or more processors, to:
a. receive a third indication that the user has selected to proceed with the selected first cooking recipe and the selected second cooking recipe; and
b. following reception of the third indication, transmit for display a plurality of additional graphical images, wherein each of the plurality of additional graphical images includes one or more steps associated with cooking the selected first cooking recipe and the selected second cooking recipe.

17. The non-transitory computer readable medium of claim 14, wherein the plurality of first cooking recipes is a plurality of main course cooking recipes, a plurality of beef cooking recipes, a plurality of fish cooking recipes, a plurality of tofu cooking recipes, or a plurality of protein cooking recipes.

18. The non-transitory computer readable medium of claim 17, wherein the plurality of second cooking recipes is a plurality of side dish cooking recipes, a plurality of dessert recipes, or a plurality of sauce cooking recipes.

19. The non-transitory computer readable medium of claim 14, wherein the subset of second food images comprises food images that are each associated with a respective second cooking recipe of a subset of the plurality of second cooking recipes, wherein each of the second cooking recipes of the subset of the plurality of second cooking recipes is associated with the selected first cooking recipe.
